(19) United States
(12) Patent Application Publication
(10) Pub. No.: US 2006/0276317 A1
(43) Pub. Date: Dec. 7, 2006

(54) Thermo roll

(76) Inventors: Reijo Pietikainen, Jarvenpaa (FI); Teemu Saarikoski, Jarvenpaa (FI); Mika Korhonen, Pori (FI); Matti Tervonen, Hyvinkaa (FI); Timo Torvi, Helsinki (FI); Jari Liimatainen, Tampere (FI); Kari Salminen, Kellokoski (FI); Eero Suomi, Hämeenlinna (FI); Mari Laakso, Jarvenpaa (FI)

Correspondence Address: STIENNON & STIENNON, 612 W. MAIN ST., SUITE 201, P.O. BOX 1667, MADISON, WI, 53701-1667, US

(21) Appl. No.: 10/570,062

(22) PCT Filed: Aug. 30, 2004
(86) PCT No.: PCT/FI04/00503

§ 371 Date: May 8, 2006

(30) Foreign Application Priority Data
Sep. 1, 2003 (FI) 20031230
Sep. 1, 2003 (FI) 20031232
Sep. 1, 2003 (FI) 20031231
Sep. 1, 2003 (FI) 20031233
Nov. 28, 2003 (FI) 20031743

(51) Int. Cl. F16C 13/00

(52) U.S. Cl. 492/59

(57) ABSTRACT

A heatable and/or coolable roll, i.e. a thermo roll, of a fibrous web machine for the treatment of a fibrous web, is, for example, for pressing and/or calendering the fibrous web in contact, i.e. in a nip, between the thermo roll and a backing member which is in contact with the thermo roll or for drying or cooling the fibrous web on the shell surface of the thermo roll. A semi-finished product of a thermo roll is manufactured using a thermo roll.

### CROSS REFERENCES TO RELATED APPLICATIONS

This application is a U.S. national stage application of International App. No. PCT/FI2004/000503, filed Aug. 30, 2004, and claims priority on FI App. No. 20031230, filed Sep. 1, 2003; FI App. No. 20031232, filed Sep. 1, 2003; FI App. No. 20031231; filed Sep. 1, 2003, FI App. No. 20031233; filed Sep. 1, 2003; and FI App. No. 20031743, filed Nov. 28, 2003, the disclosures of which are incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to fibrous web machines, advantageously to apparatus for the treatment of a paper, board, pulp or equivalent web, such as paper, board or pulp machines and finishing devices associated with them, such as calenders.

The present invention relates to a heatable and/or coolable roll, i.e. a thermo roll, of a fibrous web machine for the treatment of a fibrous web, for example, for pressing and/or calendering the fibrous web in contact, i.e. in a nip, between the thermo roll and a backing member which is in contact with the thermo roll or for drying or cooling the fibrous web on the shell surface of the thermo roll.

The present invention also relates to a thermo roll in an apparatus for the treatment of a fibrous web, which thermo roll includes a rotating cylindrical shell, a body formed of one or more parts and arranged inside the shell, at least one heat transfer medium flow passage defined by the inner surface of the shell and the outer surface of the body, a heat transfer medium, heat transfer medium conveying means for passing the heat transfer medium into the flow passage and for removing the heat transfer medium from it, as well as means for controlling the flow of the heat transfer medium to heat and/or to cool the shell by means of the heat transfer medium.

The present invention further relates to methods for using a thermo roll intended for the treatment of a fibrous web and including a shell that comprises at least two material layers, which thermo roll or the shell of which thermo roll as been provided with heat transfer means for heating and/or cooling the shell of the thermo roll, advantageously by means of a heat transfer medium.

The present invention further relates to methods for manufacturing a thermo roll intended for the treatment of a fibrous web and including a shell that comprises at least two material layers, which thermo roll or the shell of which thermo roll is provided with heat transfer means for heating and/or cooling the shell of the thermo roll, advantageously by means of a heat transfer medium.

The present invention also relates to thermo rolls intended for the treatment of a fibrous web and including a shell that comprises at least two material layers, which thermo roll or the shell of which thermo roll has been provided with heat transfer means for heating and/or cooling the shell of the thermo roll, advantageously by means of a heat transfer medium.

The present invention also relates to a semi-finished product of a thermo roll intended for the treatment of a fibrous web and including a shell that comprises at least two material layers, the shell of which thermo roll has been provided with heat transfer means for heating and/or cooling the shell of the thermo roll, advantageously by means of a heat transfer medium.

The present invention also relates to a thermo roll for manufacturing, in particular for finishing, a low-gloss and smooth fibrous web, the thermo roll being for manufacturing a low-gloss fibrous web, in particular for finishing by calendering in a device situated in a finishing line of a fibrous web machine, such as a multinip calender, a soft calender, a machine calender, a belt calender, a metal belt calender or in some combination of said calendars.

It is known to manufacture thermo rolls entirely out of chilled cast iron or steel. From FI patent 106054 it is known to manufacture a thermo roll entirely or partly by powder metallurgical means.

As prior art it is mentioned that today's heat transfer capacities of the thermo roll in calendering are 50-250 kW/m. In less demanding applications it is possible to use chilled rolls, while demanding sites of use require steel rolls.

Different coatings are known for control of wear and corrosion of the surface of the thermo roll, such as thermally sprayed metallic or ceramic coatings (Papermaking Science and Technology, Papermaking Part 3, pages 80-81).

According to EP publication 598737-B2, the highest specific heat transfer capacity of chilled rolls is 22 kW/m². With respect to technical strength, the limit of steel rolls is, however, higher, for example, the specific heat transfer capacity of the Tokuden roll is about 50 kW/m². The heat transfer capacity of steel rolls heated with oil is limited in practice by the availability of hot oil, the temperature of which is today about 300° C.

In fibrous web machines, the thermo roll must have a high heat transfer capacity, in calendering, even as high as 150-400 kW/m. In the fibrous web machines of the future, the heat transfer capacity required in impulse drying with a long nip and with increasing running speeds is considerably higher, of the order of 500-800 kW/m. With ordinary roll diameters, which are between 1.0 and 1.5 m, this means a specific heat transfer capacity of about 30-260 kW/m².

To improve heat transfer capacity, it has been proposed that the roll shell be formed of two or more material layers of different materials, so that at least one material layer conducts heat particularly well, such as copper, aluminum, a copper alloy, an aluminum alloy or equivalent, advantageous alloying elements being Sn, Zr and Cr. EP publication 723612-B1 describes a roll shell formed of different material layers. The outermost material layer is a thin copper or aluminum layer that conducts heat particularly well and the inner load-bearing base is made of steel or the like. It has been further proposed, as appears from EP publication 597814, that heat transfer passages conducting a heat transfer medium be arranged in the roll shell of a press section roll.

FI patent 106054 proposes the manufacture of a thermo roll out of two or more layers, in which the thermal conductivity of an outer layer is higher than the thermal conductivity of an inner layer. Further, said patent proposes a powder metallurgical manufacturing method.

The prior art is characterized in
that the roll or the load-bearing base of the roll is composed of steel or equivalent, whose heat transfer properties are not the best possible (typically, the thermal conductivity of the material λ<60 W/mK), and
that in order to improve the heat transfer properties of the roll, the shell of the roll is provided with a material layer that conducts heat well and/or with heat transfer passages, so that the structure of the roll is technically complex and, thus, expensive, and
that the heat transfer passages are situated in the roll shell at a distance of about 40-80 mm from the outer surface, so that with the materials used today a great temperature difference (ΔT) is created in the roll shell, which leads to a high oil temperature at high operating capacities.

### SUMMARY OF THE INVENTION

In accordance with one aspect of one embodiment of the present invention, an aim is to reduce the weaknesses associated with the prior art.

In accordance with another aspect of another embodiment of the present invention, an aim is to provide a novel roll shell to make the technical structure of the roll less complex and to improve the heat transfer properties of the roll.

These aims are achieved by the thermo roll in accordance with the invention, which thermo roll is generally characterized in that except for an optional coating and/or surface treatment layer, the shell of the thermo roll is of one metal material which conducts heat particularly well and whose thermal conductivity λ>70 W/mK.

In accordance with one embodiment of the invention, the metal material of the shell is copper or aluminum or the like. In accordance with another embodiment of the invention, the metal material of the shell is a copper or aluminum alloy or composition metal. Advantageous copper and aluminum alloys or composition metals can be produced by alloying, for example, Sn, Cr and/or Zr with copper or aluminum. By this means it is possible to produce copper and aluminum alloys or composition metals which are sufficiently strong and enable various pressing and calendering applications of low surface pressure. A material particularly suitable for the material of the shell is CuCrZr (copper-chrome-zirconium), the physical values typical of this being: density 8-10 g/cm³, thermal conductivity 300-350 W/mK and elastic modulus 100-150 GPa.

On the metallic material layer of the shell of the thermo roll, which layer is of one metal, there may be optionally a coating and/or surface treatment layer improving the wear resistance of the roll, such as a graphite coating, a metallic or ceramic hardcoating, so that the thermo roll is a coated and/or surface-treated metallic thermo roll.

The thermo roll may be an uncoated and/or non-surface-treated metallic thermo roll.

The thermo roll may have a center passage or bore for heating and/or cooling the thermo roll.

The thermo roll may have peripheral passages or bores for heating and/or cooling the thermo roll.

The thermo roll may be a cooling roll of a fibrous web.

Induction heaters may be placed inside and/or outside the shell of the thermo roll for heating the thermo roll.

The thermo roll may be a roll of a multiroll calender, a roll of a soft calender, a roll of a long nip calender, a roll of a shoe calender, a roll of a belt calender, a roll of a metal belt calender, a drying cylinder, a thermo roll in a press of a fibrous web machine and/or a thermo roll in a coating section.

The heat transfer capacity of the thermo roll may be in a range of 150-400 kW/m.

When a press dryer and a long nip are associated with the thermo roll, a heat transfer capacity may be achieved which is in a range of 150-800 kW/m.

The specific heat transfer capacity of the thermo roll may be in a range of 24-320 kW/m².

As stated above, on the metal shell made of one metal there can be optionally a coating or a surface treatment, such as a graphite coating, a metallic or ceramic hardcoating, which improves the wear resistance of the roll and the thickness of which is typically 5 mm at the most. In particular, it is possible to use a conventional hardcoating, whose thickness is 0.01-2 mm. The thermo roll in accordance with the invention is then a coated or surface-treated metallic thermo roll with high heat transfer capacity. Without coating or surface treatment, the thermo roll is an uncoated or non-surface-treated metallic thermo roll with high heat transfer capacity.

The thermo roll in accordance with the invention can be heated and cooled using known methods by means of a central center passage or by means of flow passages provided in the shell of the thermo roll. Heating is also possible by internal and/or external induction. The induction heating technique of the Tokuden type is particularly suitable for heating. Thus, the thermo roll in accordance with the present invention does not place restrictions on the selection of the heating arrangement.

Since the shell of the roll in accordance with the invention is made of one material that conducts heat well, the thickness of the shell can be made thicker and, thus, the heat transfer distance can be made longer than that of the conventional rolls, while maintaining the same heat transfer capacity. By this means, the system of flow passages of the heat transfer medium in the roll becomes less complex and peripheral passages are not necessarily even needed, which matters substantially simplify the roll arrangement.

As sites of application of the thermo roll of the invention may be mentioned in particular a calender situated in the finishing section of a paper and board machine line, in which calender the desired final properties of paper are achieved by pressing the web by means of a heated roll. The sites of application include known calender arrangements, such as a multiroll calender, a long nip calender, a belt calender and a soft calender, and in particular a shoe calender and various variants of a metal belt calender which require that thermo rolls have high heat transfer capacity.

The other sites where the thermo roll in accordance with the invention can be applied include the presses used in the press section of the paper and board machine, in particular the hot press or the so-called impulse press used for producing efficient dewatering. Further, as other sites where the thermo roll in accordance with the invention can be applied in a fibrous web machine can be mentioned the drying cylinders used in the dryer section and the thermo roll of the coating section, in particular in the process of attachment of a dry coating.

The heating and cooling delay of the thermo roll in accordance with the invention is short, so that the thermo roll in accordance with the invention is particularly suitable for fibrous web machines with a high running speed and/or for fibrous web machines in which there are substantial moisture variations in the fibrous web either in the running i.e. MD direction of the fibrous web and/or in the cross direction i.e. CD direction with respect to the running direction of the fibrous web, or substantial needs for adjusting the heating control of the roll.

The present invention thus also relates to a thermo roll in an apparatus for the treatment of a fibrous web, which thermo roll includes a rotating cylindrical shell, a body formed of one or more parts and arranged inside the shell, at least one heat transfer medium flow passage defined by the inner surface of the shell and the outer surface of the body, a heat transfer medium, heat transfer medium conveying means for passing the heat transfer medium into the flow passage and for removing the heat transfer medium from it, as well as means for controlling the flow of the heat transfer medium to heat and/or to cool the shell by means of the heat transfer medium.

This kind of thermo roll is known, for example, from U.S. Pat. Nos. 4,658,486 and 6,289,797.

In general, so-called peripherally bored tubular rolls made of steel or cast iron are used as thermo rolls, the heat transfer medium flowing in the rolls being either water or oil. Typically, the peripheral bores are passages drilled in the roll shell in the axial direction and placed at a distance of about 50-70 mm from the outer surface of the roll. A problem with peripherally drilled rolls is the complicated manufacturing process, primarily peripheral drilling, which is expensive and difficult to perform accurately such that the distance of the passages from the surface would be constant and the distribution of heat would be even. It is also typical of peripheral bores that the heat transfer medium flowing in the passages tends to cool while flowing, so that the heating effect occurring in the shell is uneven in the axial direction of the roll. To avoid this, a displacement part supported on the walls of the passage is sometimes placed in the peripheral bores in an attempt to accelerate the flow, thus improving heat transfer at the cooler end of the flow passage. Further, oil can also be conducted in opposite directions in different peripheral passages, which evens out the overall heating effect in the axial direction. One known problem with peripherally bored rolls is also that periodic variations in the circumferential direction tend to be created in the temperature distribution of the roll shell according to the placement of bores, which leads to the fact that thermal expansions cause periodic variations in the outside diameter of the roll, a so-called undulation effect, which in turn may cause barring problems.

A center passage construction of the thermo roll is also known in which the volume of the center part of a tubular roll, i.e. the so-called center passage, serves as a flow passage. To enhance the heat transfer of the flows in the center passage and to assure the axial evenness of heat transfer, it is also known to use a displacement part which is supported on the inner surface of the shell and which causes the flow to pass as a gap flow in the axial direction. The gap flow is sought to be arranged such that with a decreasing cross sectional area of the flow passage, the flow suitably accelerates causing heat transfer to be enhanced to a suitable extent. It shall be noted that when the center passage arrangement is used, there occurs no periodic “undulation disturbance” typical of peripherally bored rolls.

The above-mentioned thermo roll constructions do not, as such, make it possible to profile a fibrous web in the CD direction, i.e. in the cross direction of the fibrous web, using the oil heating arrangement described above. Typically, in connection with the manufacture and finishing of a fibrous web there occurs a need for profiling both in respect of the thickness i.e. caliper of the web and in the case of printing papers, in addition, also in respect of surface properties, in particular gloss. In these situations, an external actuating means must be used for the CD direction profiling of the web, such an actuating means being, for example, air blowing affecting locally the surface temperature of the thermo roll or a profiling induction heating means or another equivalent actuating means.

Further, it may be mentioned that the heat transfer capacity of the above-mentioned thermo roll constructions is too limited in view of today's production processes, mainly because of the limited temperature of oil (typically below 350° C.) and the low thermal conductivity of the shell material of the thermo roll.

Previously, structural improvements of the shell of the thermo roll have been proposed for improving heat transfer. In accordance with one proposal, the shell of the thermo roll is provided in the radial direction with at least one material layer made of a metal that conducts heat well, such as copper or aluminum, or of an alloy, such as a copper of aluminum alloy or composition metal (e.g. CuCrZr) or of another metal or alloy that conducts heat well. This kind of thermo roll of improved thermal conductivity is then suitable for demanding processes, such as long nip calendering and belt calendering, in which connection the required heat capacity is of the order of 200-300 kW/m, without the temperature of oil having to be raised over the temperature range of 300-350° C. In accordance with another proposal, the entire roll shell can be manufactured of a material that conducts heat particularly well, such as the above-mentioned metals, so that a center bored roll with even a relatively thick shell is suitable for said demanding process conditions. In accordance with a third proposal, the shell of the thermo roll can be manufactured by special manufacturing methods (such as by powder metallurgical means) such that peripheral passages can be constructed already in the manufacturing stage particularly close to the outer surface of the roll, so that the heat transfer distance becomes short.

A general object of the present invention is to remedy the above-mentioned drawbacks, its special object being to provide a simple and efficient heat transfer arrangement for a thermo roll, in particular by the following means:
by improving the functioning of the heat transfer flow of the center passage construction known to be simple such that the center passage construction is suitable for demanding processes, such as impulse drying and calendering, in particular for long nip, belt and metal belt calendering, in which a peripherally bored roll can be replaced with a roll in accordance with the invention,
by providing a simple way of profiling in the CD direction without external actuating means that take up much space, and
by applying the tried and inexpensive oil heating technique.

By the thermo roll is meant in this description of the invention and in the claims a roll which is intended for the treatment of a fibrous web in a fibrous web machine, such as for the pressing, drying, coating or calendering or cooling of a fibrous web, which roll can be heated and/or cooled by means of a heat transfer medium. The surface temperature of the shell part, or more briefly the shell, of the thermo roll varies, depending on the nature of the treatment process of the fibrous web, typically in a range of 20-350° C. Since in order to increase productivity it has been necessary to constantly increase the running speeds of the treatment equipment of the fibrous web, a need has arisen to improve the heat transfer capacity from the thermo roll to the fibrous web.

In accordance with one advantageous aspect of a preferred embodiment of the present invention, an object is a novel and inventive construction of the heat transfer means, such as flow passages and flow-guiding members, and the roll shell itself in a thermo roll such that the high heating and/or cooling capacity required also by efficient processes can be produced by means of a simple and advantageous technical arrangement that takes up little space.

In accordance with a second aspect of the preferred embodiment of the present invention, it is an object to provide a novel and inventive construction for arranging the flow of a heat transfer medium in the center passage of a center bored thermo roll to increase the flow velocity of the heat transfer medium and to prevent plug flow so that the center drilled roll may be used in demanding applications.

In accordance with a third aspect of the preferred embodiment of the present invention, it is an object to provide in the cross direction, i.e. CD direction, of the fibrous web a profiling effect on the fibrous web by means of the flow of the heat transfer medium.

In accordance with a fourth aspect of the preferred embodiment of the present invention, an object is the use of the thermo roll in accordance with the invention in applications that require a large heat transfer, such as, for example, calendering, in particular long nip, belt and metal belt calendering, wet pressing, coating, in particular the process for attaching dry coating, and impulse drying.

These objects are achieved by means of the present invention, the characteristic features of which are defined in the appended set of claims.

The invention is generally based on the novel and inventive basic idea that inlets and outlets, respectively, of the heat transfer medium are connected to the heat transfer medium conveying means of the thermo roll such that the heat transfer medium can be supplied into the flow passage and removed from the flow passage at more than one axial position of the thermo roll.

In accordance with one embodiment of the invention, a speed difference is arranged between the wall surfaces of the shell and the body to enhance the flow of the heat transfer medium.

In accordance with one embodiment of the invention, the body of the thermo roll is non-revolving.

In accordance with one embodiment of the invention, in at least one flow passage, the height of the flow passage, i.e. the gap distance in a flow gap, or the length of the flow gap in the flow direction is adjustable at at least one point over the axial length of the roll to profile the temperature of the shell in the axial direction.

In accordance with one embodiment of the invention, the means for controlling the heat transfer medium are movable in the radial direction or their shape can be adjusted in said direction to adjust the gap distance in the flow gap.

In accordance with one embodiment of the invention, the means for controlling the heat transfer medium are movable in the axial direction or in the circumferential direction or their size and shape can be changed in said directions to adjust the gap distance in the flow gap within a desired range.

In accordance with one embodiment of the invention, the means for controlling the heat transfer medium are formed of a throttling or displacement part which acts in the flow passage and which is movable towards the inner surface of the shell or away from the inner surface of the shell.

In accordance with one embodiment of the invention, the body of the thermo roll is adjustable in shape or size.

In accordance with one embodiment of the invention, the gap distance in the flow gap is about 1-50 mm, advantageously about 5-25 mm.

In accordance with one embodiment of the invention, a throttling means limiting the flow in the gap is arranged in the flow passage between the inlets and the outlets of the heat transfer medium. In accordance with one embodiment, this throttling means is adjustable.

A speed difference may have been arranged between the wall surfaces of the flow passage, which speed difference produces a pumping effect in the heat transfer medium.

In accordance with one embodiment of the invention, the flow velocity and the flow quantity in the system of distribution passages supplying the heat transfer medium to the flow passage are adjustable in a position-specific manner with respect to the axial direction of the roll.

In accordance with one embodiment of the invention, the thermo roll comprises, in the area between the inner surface of the shell and the outer surface of the body, means for controlling the flow velocity in the flow passage of the heat transfer medium to control the temperature of the shell or the thermal expansions of the shell over the entire length of the thermo roll either evenly or in a profiled manner.

In accordance with one embodiment of the invention, the temperature of the heat transfer medium in the system of distribution passages supplying the heat transfer medium to the flow passage is adjustable in a position-specific manner with respect to the axial direction of the roll.

In accordance with one embodiment of the invention, the material of the shell is a metal material that conducts heat particularly well, such as copper, tin, aluminum, zinc, chrome, zirconium or an equivalent metal material that conducts heat well or an alloy or a composition metal formed of at least two of these materials. The metal material alloy is CuCrZr in accordance with one embodiment.

In accordance with one embodiment of the invention, the material of the roll shell is mainly iron-based alloys, such as cast iron or steel.

In accordance with one embodiment of the invention, fixed support is arranged for the body disposed inside the shell of the thermo roll or a center of mass eccentric with respect to the thermo roll is arranged in the body to prevent free rotation of the body.

The use of the thermo roll in accordance with the invention enables calendering, in particular long nip, belt and metal belt calendering, wet pressing, impulse drying and coating and cooling of a fibrous web in applications that demand a large heat transfer.

In accordance with one embodiment of the invention, the flow gap of the flow passage, which is adjustable in length and/or height, causes the flow in the flow passage to be accelerated and the effect of heat transfer to be enhanced. An advantageous gap distance is in a range of about 1-50 mm, preferably in a range of about 5-25 mm. Further, by adjusting the height or length of the flow passage locally in an axial position, it becomes possible to control the flow and/or the heat transfer of the heat transfer medium in a position-specific manner in the axial direction for controlling the temperature distribution of the shell over the entire length of the thermo roll either evenly or by profiling in a controlled manner. In that connection, it is advantageous that in the inner body of the roll there are profiling blocks or flow guides, one of them being, for example, a projection part connected to the body part and movable in the radial, circumferential or axial direction. Such a profiling block forms, in one embodiment of the invention, a movable throttling and/or displacement part of the flow of the heat transfer medium.

In accordance with one embodiment of the invention, the flow of the heat transfer medium is controlled in the flow passage by means of the throttling or displacement part, by means of which the gap flow passage of the heat transfer medium can be made narrower and/or lower. The forced flow occurring in the narrowed passage accelerates, with the result that the boundary layer of the flow becomes thinner and the level of turbulence increases, causing heat transfer from the heat transfer medium to the shell to be enhanced. In other words, heat transfer can be controlled by accelerating and/or by throttling the flow of the heat transfer medium in the flow passage by means of the control means.

Since the rotary motion of the roll shell contributes to the flowing of the heat transfer medium in the flow gap in the rotation direction of the periphery of the thermo roll shell, and this flow tends further to rotate the inner body of the roll, this effect is cancelled in accordance with one embodiment of the invention either by arranging an eccentric center of mass in the roll body, in which case free rotation of the freely journalled roll body is prevented, or by means of fixed support of the roll body.

In accordance with one embodiment of the invention, the metal material of the shell is advantageously copper, aluminum or an equivalent metal material that conducts heat well or a metal material alloy or composition metal that conducts heat well. The shell can also be made of a conventional material, such as cast iron, steel, or the like. An advantageous metal material alloy is, for example, a copper or aluminum alloy or composition metal, in which connection, for example, Cr, Sn, Zr are advantageous alloy materials. One particularly advantageous metal material alloy for the shell is CuCrZr.

When the shell conducts heat well and when the flow passage of the heat transfer medium comprises flow control means, traditional peripheral bores can be omitted from the thermo roll and the thermo roll in accordance with the invention can be used in applications that require a large heat transfer, said applications including, for example, calendering, in particular long nip, belt and metal belt calendering, wet pressing, impulse drying and process steps associated with coating.

In accordance with one advantageous embodiment of the invention, the main parts of the thermo roll are formed by the shell part of the roll and by the volume defined by the shell inside itself, which volume serves as the flow passage of the heat transfer medium, in said volume being additionally placed one or more body parts separate from the shell and displacing and controlling the flow.

In accordance with one embodiment of the invention, a mutual speed difference is arranged between the inner wall of the roll shell and the wall surfaces of the body parts inside the shell to enhance the flow of the heat transfer medium.

In the thermo roll in accordance with the invention, the flow of the heat transfer medium is arranged to pass in a flow gap between the shell part and the body part, its direction being substantially in the rotation direction of the periphery of the roll, i.e. in the circumferential direction, thus differing from the traditional thermo roll in which the flow in the flow gap is mainly axial with respect to the rotary motion of the roll. The flow in the circumferential direction of the roll provides the advantage that the oil which cools while it flows does not cause temperature differences in the axial direction of the thermo roll. Entry and exit openings of the flow medium, i.e. inlet and outlet openings of the flow medium, are arranged in connection with the center part, i.e. the body part, of the thermo roll substantially across the entire width of the roll. In accordance with an advantageous embodiment of the invention, the flow is arranged to pass in a narrow flow gap over a significant part of the circumferential length of the roll, which is at least 20% of the circumferential length, so that the height of the flow gap is 1-50 mm, advantageously 5-25 mm. The body part inside the shell is particularly advantageously substantially non-revolving, so that the flow of the heat transfer medium is arranged to pass in the flow passage in a flow gap in which there is a considerable speed difference between the opposite walls, whereby a strong shear field is created in the flow, which benefits heat transfer effectively. In accordance with an advantageous embodiment, there is, in practice, a speed difference of 20-30 m/s between the non-revolving body and the rotating shell, which means that the mean flow velocity of oil is 10-15 m/s with respect to both the stationary body part and the rotating shell part. The flow velocity is thus significantly higher than that of the conventional peripheral passage and center passage flow (1-4 m/s), which means greater turbulence and, thus, more efficient heat transfer. The energy required by the shear field and the turbulence caused by the speed difference between the shell and the body is obtained from the rotary motion of the shell.

By arranging the oil inlet and outlet openings suitably and by disposing a suitable throttling or obstruction part in the area between said inlet and outlet openings, the rotary motion of the shell produces a substantial pumping effect in that portion between the outlet and inlet openings which is without said obstruction part, the energy for said pumping effect being taken from the rotary motion of the shell. The need for separate pumping is reduced and a high flow rate is achieved, which means a large heat transfer capacity. In other words, the roll itself serves as a pump. In addition, the pumping effect is enhanced with increasing speed, precisely when more capacity is also needed.

The heat transfer properties of the shell of the thermo roll can be arranged to be effective by manufacturing the shell out of a material that conducts heat well (λ>70 W/m²K). The shell can be manufactured, for example, of CuCrZr.

The heat transfer of the gap flow can be controlled, i.e. profiled, in the CD direction in at least the following ways:
by profiling the temperature of the oil coming from the system of distribution passages locally in the CD direction,
by profiling the flow quantity in the inlet or outlet passages, for example, by changing the degree of throttling locally in the CD direction by profiling blocks,
by controlling the height of the flow gap or the length of the flow direction locally, for example, mechanically either by moving or bending the body part of the roll or by adjusting the shape or size of some part of the body part of the roll or by regulating a separate actuating means connected to the body part,
by controlling the viscosity of the heat transfer medium flowing in the flow gap, for example, by means of a magnetic or electric field in the case when a magneto- or electrorheological liquid serves as the heat transfer medium, which liquid is described, for example, in the publication WO 02064886.

The heat transfer arrangement can be combined with a conventional peripherally drilled roll, in which connection it is possible to make use of both the peripheral bores and the center passage. Of course, the prior known profiling methods can also be used in connection with thermo roll intended in the invention.

The present invention then further relates to thermo rolls intended for the treatment of a fibrous web, to methods for using a thermo roll intended for the treatment of a fibrous web, to methods for manufacturing a thermo roll intended for the treatment of a fibrous web, and to a semi-finished product of a thermo roll intended for the treatment of a fibrous web and including a shell that comprises at least two material layers, the shell of which thermo roll has been provided with heat transfer means for heating and/or cooling the shell of the thermo roll, advantageously by means of a heat transfer medium.

Here, by the thermo rolls are meant heatable thermo rolls which are used in fibrous web working devices used in the manufacture of a paper, pulp and board web and equivalent fibrous webs and whose shell is multi-layered or layered. Such thermo rolls include, for example,

a roll in a press section, in particular a roll in an impulse press,

a drying cylinder in a dryer section,

a thermo roll in a machine calender, a so-called ‘breaker stack’ calender, a soft calender, a multinip calender, a supercalender, a long nip calender and/or a belt calender or a metal belt calender or another calender of a fibrous web machine,

a thermo roll in a coating section of a fibrous web machine.

By the multi-layered or layered thermo roll is meant here a thermo roll shell structure that comprises material layers which are visually, physically, chemically or metallurgically distinguishable or separable from one another. Each material layer has its own individual material properties, which may be different from those of an adjacent layer. By the layer of the shell of the thermo roll is meant each layer of the shell of the thermo roll or part of the shell material which is a layered whole in the sense of the manufacturing technique, the material properties of which layered whole can be the same as those of the layer made by a manufacturing technique and situated on its inner or outer side.

Two principal objects of the operation of the thermo roll are to transfer enough heat to the fibrous web and to serve as a support surface for the fibrous web treated in the fibrous web machine.

Oil heating has been most commonly used as heating systems in thermo rolls, with heated oil flowing in heat transfer medium flow passages which are situated in the shell of the thermo roll and which are most often formed of peripheral bores situated in the surface part of the thermo roll shell. Water and steam are also other traditional heat transfer mediums. The center passage of the thermo roll, i.e. a passage drilled in the center line, or a hollow inner part of the thermo roll has also been used as a flow passage for the heat transfer medium.

In addition to the foregoing, it is known to use heating accomplished by means of electric resistors, and induction heating from outside. The thermo roll has also been heated merely by induction heating from inside. Such a thermo roll is, for example, the Tokuden roll. In the Tokuden roll, a steel shell rotates around a fixed shaft provided with integrated induction coils. Passages partly filled with a liquid are arranged in the rotating steel shell to even out the temperature distribution.

Either chilled cast iron or steel has been mainly used as the shell material of the prior art thermo rolls, so that the shell of the entire thermo roll is thermally, in principle, of one and the same material. Today's thermo rolls are mainly peripherally bored chilled or steel rolls.

In a multi-layered chilled roll

an outer layer typically having a thickness of about 10-30 mm is of cast iron, advantageously of “chill cast” iron, with thermal conductivity A in a range of 20-25 W/mK,

under this there is an intermediate layer, a so-called “mottle” layer, whose thickness is typically about 20-30 mm, with λ in a range of 20-50 W/mK, and

an inner part, i.e. the innermost layer, is typically of so-called grey cast with thermal conductivity λ in a range of about 45-60 W/mK.

As a general rule, in known chilled rolls with a multi-layered shell, thermal conductivity thus decreases towards the outside. In steel rolls, the effective thermal conductivity λ, i.e. the effective mean value of thermal conductivity, across the shell is in a range of about 20-40 W/mK depending on the material.

Peripheral bores are generally at a distance of at least 55-65 mm from the outer surface, when measured from the center line. Thus, in chilled rolls they are, in practice, in the inner layer, i.e. in the grey cast, just below the intermediate layer. An important reason for this is that the boundary surface of a harder material is easy to drill. The number and the diameter of bores vary. Typically, there are at least 20-50 bores and their diameter is about 30-40 mm.

Poor strength, brittleness and non-uniformity of the material are significant problems with chilled rolls. Because of poor strength and brittleness, the material does not withstand high tensile stresses, which may arise in intensive heating or cooling situations, which include in particular error and emergency situations in the fibrous web process. For example, large heat transfer from inside the thermo roll through the outer surface to the web or from the web through the outer surface of the thermo roll into the thermo roll or the cooling/heating of the thermo roll all cause great temperature differences in the shell and, in particular, in the boundary surface/surfaces of the material layers, so that different thermal stresses and thermal expansions cause high shear forces, which may break the thermo roll. To avoid high shear forces, today's thermo rolls are cooled and heated slowly. This causes process delays, which increases production costs and production problems.

The non-uniformity and instability of the material of chilled rolls cause problems in the dynamics of rotating rolls, so that vibrations, among other things, “barring” and balancing become problematic in particular in multinip calenders. One reason is variations in the thickness of a single layer caused by the manufacturing technique, so that the thermo roll bends when heated, i.e. because of asymmetric thermal expansion, a thermo roll that is well balanced as cold can bend and be poorly balanced at operating temperature. The instability of the inner layer, which is typically made of grey cast, in turn causes that, for example, the loads (bending) applied during transport and treatment produce small permanent deformations (deflections), which are seen only at the end-use site while the thermo roll rotates (vibrations).

To avoid the problems encountered in connection with chilled rolls, increasing use has been made of steel materials in the most demanding process situations. In that case, the advantages include, among other things, a better uniformity and stability and a considerably higher strength of the material properties.

A problem associated with the manufacturing technique of both chilled rolls and steel rolls is that the peripheral bores are expensive and difficult to make. A large number of bores are needed and they must be placed relatively far from the surface of the thermo roll in order that the temperature distribution might be made sufficiently uniform and in order that the locations and misalignments of bores should be of less significance. It is difficult to drill longitudinal holes in the roll shell. It is usually necessary to drill two opposing holes from different directions. To speed up the evenness of heating and the heating and cooling steps, it would be advantageous to drill in the shell a larger number of flow passages than done today. So far it has not been possible to do so because of the demanding nature of the technique and because of costs.

In chilled rolls, the bores are placed in the soft inner layer, i.e. typically in the so-called grey cast. A high oil temperature inevitably follows from the long heat transfer distance between the bores and the surface since the thermal conductivity of materials is relatively poor both in chilled rolls and in steel rolls.

The diameter of the flow passages is generally constant over their entire length. However, from the viewpoint of the evenness of heat transfer, the location and the cross-sectional area of the passages and the circumferential length of their walls should, however, change in a manner corresponding to the change of heating oil temperature in the direction of motion of the flow. In accordance with the prior art, this has been achieved by changing the distance between the passage and the outer surface of the roll shell, by throttling the flow by means of a separate throttling part, with the result that the cross-sectional area is reduced and the flow velocity increases, or by making the area of the wall larger by roughening, grooving, enlarging, etc. An often used way of evening out differences in the heating temperature in the axial direction is also to arrange the direction of the flow in adjacent flow passages in different directions.

The placement of flow passages close to the outer surface of the thermo roll is advantageous because the heat transfer distance to the outer surface of the thermo roll then becomes short. In that case, however, it becomes a problem that it is, however, necessary to use a relatively dense spacing of the flow passages in order to minimize the so-called undulation phenomenon, i.e. in the case of a roll, the waviness of the thermo roll's roundness profile arising from local differences in thermal expansion caused by the heating passages of the thermo roll, and the change of the temperature of the outer surface of the thermo roll varying in an undulating manner.

The undulation phenomenon is known to induce roll vibrations and adversely affect the properties of the paper being treated in the process, which may be visible, among other things, as gloss and thickness differences in the paper.

A problem with known thermo rolls has also been the lack of sufficiently quick cooling of the thermo roll. For example, in connection with roll replacement, the thermo roll should be cooled quickly in order to avoid unnecessary process delays. A drawback of the heating arrangements accomplished by means of electricity has been the lack of a cooling system.

One big problem with the rolls heated from inside, such as the Tokuden rolls provided with internal induction heating, is the relatively high heat transfer resistance caused by a thick shell. Because of the low thermal conductivity of the shell material, the temperature difference between the inner parts of the thermo roll and the outer surface of the thermo roll is great, readily of the order of 100° C. This is a special problem in this kind of Tokuden roll in which the inner surface of the roll is subjected to heating and the heat transfer distance to the outer surface is large. The heat transfer of the shell thus limits the specific capacity density (per unit area) so that to achieve the same total capacity (nip capacity) it is necessary to use larger roll diameters.

New calendering concepts require a large heat capacity transfer from the thermo roll to the fibrous web in the process, which means that the thermal properties of the materials of the thermo roll shell are of great significance. Likewise, the material's resistance to thermal shocks is important.

A problem with the known thermo rolls of the above-mentioned type, when using new calendering methods, i.e. hot multinip calendering or long nip calendering, is too slight a heat capacity transfer to a moist fast-moving web. Typical values are the desired surface temperature of the thermo roll shell of 200-250° C. and a heat capacity of 150-250 kW/m in the shell of the thermo roll. The heat capacity can be even as much as 400 kW/m if the process includes the moisturizing of the web with water before the nip.

A problem with the prior art thermo roll arrangements is that the heat capacity produced by mere oil heating is not able to keep the surface temperature of the thermo roll at a sufficiently high level with a sensible oil temperature of <300-350° C. and with sensible roll diameters of <1.5 m. To increase heat capacity, in the multinip calender there is no space for accommodating external induction heating, and the price of external induction heating is not yet today competitive as compared with oil heating.

In respect of material properties, such as elongation at fracture, tensile strength, thermal conductivity properties, a thermo roll of mere chilled cast iron, which is, for example, of grey cast iron, is not suitable for the transfer of a large heat capacity of the above-mentioned kind because thermal stresses exceed the properties of the material. In the chill casting process, a certain number of non-uniform material properties are always created, which also causes deflection errors when the thermo roll is heated/cooled as well as balancing and vibration problems at high speeds of rotation. The strength properties of the material of the thermo roll made totally of steel again allow great temperature differences but the above-mentioned highest sensible temperature of heating oil limits the heat capacity that is achieved. In the known structures, great temperature differences between oil and the achieved surface temperature of the thermo roll are largely due to the poor heat transfer properties of the material of the thermo roll shell material and to a long heat transfer distance, which limit the density of heat flux.

Because of the high heat capacity demand of the process, the thermal conductivity of the thermo roll shall be substantially improved in order that it may be assured that enough heat capacity is transferred through the shell of the thermo roll to the nip and further to the fibrous web that is treated. To enhance heat transfer, the heat transfer distance between the outer surface of the thermo roll shell and the heat transfer area shall also be reduced.

A general object of the present invention is to eliminate or at least substantially reduce the above-mentioned drawbacks and weaknesses and to improve the heat transfer properties of the thermo roll.

In accordance with one aspect of the present invention, a general object is to provide a novel and inventive thermo roll whose operating and heat transfer characteristics are made more effective, in particular the object is to improve

heat transfer from inside the thermo roll to the outer surface of the thermo roll,

heat transfer from the outer surface of the thermo roll into the thermo roll,

heating of the thermo roll shell, and

cooling of the thermo roll shell.

In accordance with an aspect of the present invention, a general object is to provide a method for using a thermo roll intended for the treatment of a fibrous web.

In accordance with an aspect of the present invention, a general object is to provide a novel and inventive method for manufacturing a thermo roll.

In accordance with an aspect of the present invention, a general object is to provide a novel and inventive semi-finished product of a thermo roll.

These objects are achieved by the present invention, the characteristic special features of which are defined in the appended set of claims.

In accordance with an embodiment of the invention, the thermo roll is generally characterized in that at least two different material layers are arranged, using a manufacturing technique, radially one within the other in the shell of the thermo roll, which material layers are manufactured with respect to their manufacturing technique in different stages or by different methods, and that there are heat transfer medium flow passages confined by at least one of said material layers inside itself or situated in a boundary zone of said material layers.

The thermal conductivity of each material layer of the shell of the thermo roll may be in a range of 20-70 W/mK.

The material layers of the shell of the thermo roll may have been manufactured of a conventional material, such as a ferrous metal, advantageously steel or cast iron.

In accordance with an embodiment of the invention, the thermo roll is generally characterized in that material layers are arranged radially one within the other in the shell of the thermo roll, so that the thermal conductivities of at least two material layers are different from one another, and that there are heat transfer medium flow passages in at least one of said material layers or confined by at least one of said material layers inside itself or situated in a boundary zone of said material layers, the thermal conductivities of which material layers are different from one another.

At least one of said material layers, the thermal conductivities of which are different from one another, may be a heat transfer layer which is of a metal material that conducts heat particularly well, the effective thermal conductivity of the thermo roll across the shell of the thermo roll being >70 W/mK.

The heat transfer layer of the thermo roll may be copper, brass, tin, aluminum, zinc, chrome, zirconium or a similar material that conducts heat particularly well or an alloy or a composition metal composed of at least two of these materials.

The material alloy of the heat transfer layer may be CuCrZr.

A flow passage may have been arranged entirely or at least partly in the material layer of the shell of the thermo roll forming the heat transfer layer which conducts heat particularly well and is a surface layer of the shell and/or a material layer on the inner side of the surface layer of the shell.

A flow passage may have been arranged in a material layer of the shell of the thermo roll situated on the inner or on the outer side of the heat transfer layer.

The heat transfer layer may be the innermost material layer of the shell of the thermo roll.

The material layer of the shell of the thermo roll forming the heat transfer layer may have been arranged to extend in the axial direction of the thermo roll substantially only across the width of the web area of the fibrous web such that substantially outside the web area the shell of the thermo roll is formed of a material that is thermally less conductive than the heat transfer layer.

The heat transfer layer and the surface layer of the thermo roll may be of the same material.

The thermal conductivity of the material layers arranged in the shell of the thermo roll may change in a layer by layer fashion in the radial direction of the thermo roll.

In respect of the thermal conductivities of the material layers of the thermo roll the heat transfer layer may have the best thermal conductivity.

The heat transfer layer may be on the inner side and/or on the outer side of a thermally less conductive material layer.

The layer thickness of the surface layer may be smaller than the layer thickness of the heat transfer layer, and that the heat transfer layer may be of a copper alloy, for example, CuCrZr, brass, tin, aluminum, zinc, chrome, zirconium, nickel, iron, steel or an alloy containing above-mentioned metals, and that the surface layer may be of a material selected from a group including steel, such as low carbon steel, a hardcoating, such as a chrome coating or a ceramic coating.

In the outer surface of some material layer situated on the inner side of the surface layer there may be a recess or a groove, whose cross-sectional profile shape constitutes a portion of the cross-sectional profile of the flow passage, so that the recess or the groove forms the flow passage together with the inner surface of the outer material layer.

In the inner surface of the surface layer and/or in the inner surface of the layer situated on the inner side of the surface layer there may be a recess or a groove, whose cross-sectional profile shape constitutes a portion of the cross-sectional profile of the flow passage, so that the recess or the groove forms the flow passage together with the outer surface of the inner material layer.

The thermo roll may comprise a system of heat transfer medium flow passages such that the heat transfer distance between the outer surface of the surface layer of the shell and the system of flow passages of the thermo roll has been arranged to be short such that at least some of the flow passages have been placed, as measured from their center line, advantageously at a distance of 50 mm at the most, more advantageously at a distance of 10-40 mm, from the outer surface of the thermo roll.

There may be a flow tube in the flow passage.

A heat capacity in a range of 100-300 kW/m, preferably in a range of 200-250 kW/m, may be transferred from the thermo roll to the fibrous web such that the temperature of the heat transfer medium remains below 350° C.

The thermo roll may be intended for different pressing and calendering applications of low surface pressure.

A first method for using a thermo roll according to the invention is generally characterized in that from a thermo roll whose shell comprises at least two different material layers which are arranged, using a manufacturing technique, radially one within the other, which material layers have been manufactured with respect to their manufacturing technique in different stages or by different methods, a system of heat transfer medium flow passages being placed in at least one of said material layers or confined by at least one of said material layers inside itself or situated in a boundary zone of said material layers, a heat capacity in a range of 100-300 kW/m, preferably in a range of 200-250 kW/m, is transferred to the fibrous web such that the temperature of the heat transfer medium is kept <350° C.

A second method for using a thermo roll according to the invention is generally characterized in that from a thermo roll whose shell comprises at least two material layers which are placed radially one within the other and which are different in their thermal conductivities, a system of heat transfer medium flow passages being placed in at least one of said material layers or confined by at least one of said material layers inside itself or situated in a boundary zone of said material layers, a heat capacity in a range of 100-300 kW/m, preferably in a range of 200-250 kW/m, is transferred to the fibrous web such that the temperature of the heat transfer medium is kept <350° C.

In said method during the heating or cooling of the thermo roll a separate heat transfer passage system may be used in a material layer that conducts less heat to even out the temperature difference inside the thermo roll such that thermal stresses remain in a range that causes no fatigue in the structure.

A first method for manufacturing a thermo roll according to the invention is generally characterized in that at least two material layers which are different in their manufacturing technique are arranged radially one within the other in the shell of the thermo roll, which material layers are manufactured with respect to their manufacturing technique in different stages or by different methods, and that heat transfer medium flow passages are arranged to be confined by at least one of said material layers inside itself or to be situated in a boundary zone of said material layers.

In the said method the material layers of the shell of the thermo roll may be manufactured of a material whose thermal conductivity is in a range of 20-70 W/mK.

The material layers of the shell of the thermo roll may be manufactured of a conventional material, such as a ferrous metal, advantageously steel or cast iron.

A second method for manufacturing a thermo roll according to the invention is generally characterized in that different material layers are arranged in layers radially one within the other in the shell of the thermo roll, the thermal conductivities of at least two of said material layers being different from one another, and that heat transfer medium flow passages are arranged in at least one of said material layers or to be confined by at least one of said material layers inside itself or to be situated in a boundary zone of said material layers.

At least one material layer of the thermo roll may be manufactured using hot isostatic pressing (HIP) or by casting or by forging.

The shell of the thermo roll may be fixed or assembled by welding, for example by friction stud welding, soldering, thermal contraction, by means of bolts, using an interlocking joint, by casting or using hot isostatic pressing (HIP).

The flow passages may be formed in the shell of the thermo roll by machining, for example, by milling, drilling or forging, or by pressing, for example using hot isostatic pressing (HIP), or by etching.

A heat transfer layer made of a metal material that conducts heat particularly well may be arranged to form at least one of said material layers, so that the effective thermal conductivity λ of the thermo roll across the shell of the thermo roll is >70 W/mK.

The heat transfer layer may be made of copper, brass, tin, aluminum, zinc, chrome, zirconium or of a material having similar heat transfer properties or of an alloy or a composition metal composed of at least two of these materials.

CuCrZr may be selected for the material alloy of the heat transfer layer.

The material layer of the shell of the thermo roll forming the heat transfer layer may be arranged to extend in the axial direction of the thermo roll substantially only across the web width of the fibrous web such that substantially outside the web area the shell of the thermo roll is formed of a material that is thermally less conductive than the heat transfer layer.

The heat transfer layer and the surface layer of the thermo roll may be formed of the same material.

The material layers of the shell of the thermo roll may be formed of an iron-based metal, advantageously steel.

A system of heat transfer medium flow passages may be arranged in the thermo roll such that the heat transfer distance between the outer surface of the surface layer of the shell and the system of flow passages of the thermo roll is arranged to be short such that at least some of the flow passages may be placed, measured at their center line, advantageously at a distance of 50 mm at the most, preferably at a distance of 10-40 mm from the outer surface of the thermo roll.

A flow passage may be arranged entirely or at least partly in the surface layer of the shell of the thermo roll and/or entirely or at least partly in the material layer on the inner side of the surface layer of the shell.

The inner surface and/or the outer surface of the material layer intended for the shell of the thermo roll may be provided with recesses or grooves, whose cross-sectional profile shapes constitute a portion of the cross-sectional profiles of the flow passages formed in the shell of the thermo roll, so that the recesses or the grooves form flow passages together with the inner surface of the outer material layer or with the outer surface of the inner material layer to receive the flow of the heat transfer medium.

The recess or the groove forming the flow passage of the thermo roll may be filled in an earlier manufacturing stage with a soft material, for example with copper, which is drilled open in a later manufacturing stage or drilled open in a full-size roll.

A flow tube may be placed in the flow passage.

A thermo roll according to an embodiment of the invention is generally characterized in that at least two material layers which are different in their manufacturing technique have been arranged radially one within the other in the shell of the thermo roll, which material layers have been manufactured with respect to their manufacturing technique in different stages or by different methods, and that there are heat transfer medium flow passages confined by at least one of said material layers inside itself or situated in a boundary zone of said material layers.

The material layers of the shell of the thermo roll may have been manufactured of a material whose thermal conductivity is in a range of 20-70 W/mK.

The material layers of the shell of the thermo roll may have been manufactured of a conventional material, such as a ferrous metal, advantageously steel or cast iron.

A thermo roll according to an embodiment of the invention is generally characterized in that material layers have been arranged in stages or in layers radially one within the other in the shell of the thermo roll, the thermal conductivities of at least two of said material layers being different from one another, and that there are heat transfer medium flow passages in at least one of said material layers or confined by at least one of said material layers inside itself or situated in a boundary zone of said material layers.

At least one of said material layers, the thermal conductivities of which are different from one another, may be a heat transfer layer which is of a metal material that conducts heat particularly well, the effective thermal conductivity λ of the thermo roll across the shell of the thermo roll being >70 W/mK.

The heat transfer layer may be made of copper, brass, tin, aluminum, zinc, chrome, zirconium or a material having similar heat transfer properties or an alloy or a composition metal composed of at least two of these materials.

The material alloy of the heat transfer layer may be CuCrZr.

A flow passage may have been arranged entirely or at least partly in the surface layer of the shell of the thermo roll and/or entirely or at least partly in the material layer on the inner side of the surface layer of the shell.

A flow passage may have been arranged in the material layer of the shell of the thermo roll situated on the inner side of the heat transfer layer.

The heat transfer layer may be the innermost material layer of the shell of the thermo roll.

In the outer surface of some material layer situated on the inner side of the surface layer there may be a recess or a groove, whose cross-sectional profile shape constitutes a portion of the cross-sectional profile of the flow passage, so that the recess or the groove forms a flow passage together with the inner surface of the outer material layer.

In the inner surface of the surface layer and/or in the inner surface of the layer on the inner side of the surface layer there may be a recess or a groove, whose cross-sectional profile shape constitutes a portion of the cross-sectional profile of the flow passage, so that the recess or the groove forms a flow passage together with the outer surface of the inner material layer.

The material layer of the shell of the thermo roll forming the heat transfer layer may have been arranged to extend in the axial direction of the thermo roll substantially only across the width of the web area of the fibrous web such that substantially outside the web area the shell of the thermo roll is formed of a material that is thermally less conductive than the heat transfer layer.

The heat transfer and the surface layer of the thermo roll may be of the same material.

The thermal conductivity of the material layers arranged in the shell of the thermo roll may be different in a layer by layer fashion in the radial direction of the thermo roll.

In respect of the thermal conductivities of the material layers of the thermo roll the heat transfer layer may have the best thermal conductivity.

The heat transfer layer may be on the inner side and/or on the outer side of a thermally less conductive material layer.

The material layers of the shell of the thermo roll may be of an iron-based metal, advantageously steel.

The thermo roll may comprise a system of heat transfer medium flow passages such that the heat transfer distance between the outer surface of the surface layer of the shell and the system of flow passages of the thermo roll has been arranged to be short such that at least some of the flow passages may have been placed, measured at their center line, advantageously at a distance of 50 mm at the most, preferably at a distance of 10-40 mm from the outer surface of the thermo roll.

A flow tube may be placed in the flow passage.

The layer thickness of the surface layer may be smaller than the layer thickness of the heat transfer layer, and the heat transfer layer may be of a copper alloy, for example, CuCrZr, brass, tin, aluminum, zinc, chrome, zirconium, nickel, iron, steel or an alloy containing above-mentioned metals, and the surface layer may be of a material selected from a group including steel, such as low carbon steel, a hardcoating, such as a chrome coating or a ceramic coating.

A heat capacity in a range of 100-300 kW/m, preferably in a range of 200-250 kW/m, may be transferred from the thermo roll to the fibrous web such that the temperature of the heat transfer medium remains below 350° C.

The thermo roll may be intended for different pressing, cooling and calendering applications of low surface pressure.

A semi-finished product of the thermo roll according to the invention is generally characterized in that an inner surface and/or an outer surface of a material layer intended for the shell of the thermo roll is provided with recesses or grooves, whose cross-sectional profile shapes constitute a portion of the cross-sectional profiles of flow passages to be formed in the shell of the thermo roll, so that the recesses or the grooves form flow passages together with the inner surface of an outer material layer or with the outer surface of an inner material layer to receive a heat transfer medium flow or heat transfer medium flow tubes.

In the semi-finished product the flow passage may have been formed by axial drilling or by spiral machining, for example, by milling, which may be entirely in a material layer of the shell of the thermo roll and/or may open to the inner or outer surface of the a material layer.

The structure of the shell of the thermo roll in accordance with an embodiment of the invention is such that the properties of the material, in particular thermal conductivity and mechanical strength, are designed to change in a layer by layer fashion in the radial direction of the thermo roll to improve the operating characteristics of the thermo roll. Since it is generally not possible to achieve the optimum with respect to thermal conductivity and mechanical strength simultaneously with the same material, in accordance with this arrangement of the invention a material having the best property in view of the whole is selected for each individual layer in the radial periphery of the thermo roll.

In accordance with an embodiment of the invention, the material layer with the best thermal conductivity is most preferably placed between the system of flow passages and the outer surface of the shell in an area that is as large as possible to form a heat transfer layer. This provides efficiency in heat transfer, so that the temperature between the flowing medium, advantageously oil, and the surface becomes low. When selecting a combination of materials for different layers, strength and thermal expansions and the stress state created in connection with the use of the thermo roll have been taken into account as limitations.

A particularly essential feature of an embodiment of the invention is the material layers which are arranged radially one within the other in the shell of the thermo roll and of which, in accordance with one embodiment, the thermal conductivity of at least two is different.

The invention also makes it possible to arrange the layers of the thermo roll shell such that thermal conductivity can be the same in different layers, so that the material of the layers of the shell which are different in respect of the manufacturing technique is, for example, chemically of the same conventional material, for example, advantageously steel.

The flow passages of the heat transfer medium arranged in the shell or in the heat transfer layer of the shell of the thermo roll in accordance with the invention can be, for example, heat transfer bores or heat transfer tubes that extend in the axial direction mainly parallel to the center axis of the thermo roll or that run spirally with respect to the axis of the thermo roll. The flow passages of the heat transfer medium can also run in the shell of the thermo roll turning spirally around the axial rotation axis of the thermo roll.

In the forming of some material layer and the flow passages of the thermo roll it is possible to use, as an advantageous manufacturing method, hot isostatic pressing, i.e. the HIP method, of which the term ‘hot pressing’ is also used hereafter in this connection.

In accordance with an embodiment of the invention, it is advantageous to place flow passages in the shell of the thermo roll already in the manufacturing stage, thus avoiding massive drillings of a full-size thermo roll. However, the flow passages are not necessarily finished immediately directly in connection with the manufacture of the shell or some layer of the shell of the thermo roll without chip removal but, for example, in connection with hot pressing it is possible to leave in the locations of the flow passages a guide groove or a tube or soft metal which is, for example, drilled open when the roll has been assembled. The drilling of a full-size thermo roll can be avoided by manufacturing the thermo roll by assembling the thermo roll of several coaxial roll sections. In that case the flow tubes of the heat transfer medium can also be drilled at an oblique angle with respect to the axial direction parallel to the rotation axis of the thermo roll to provide spirally running heat transfer medium flow passages in the full-size thermo roll.

In accordance with an advantageous embodiment of the invention, the heat transfer distance between the outer surface of the thermo roll shell and the heat transfer area of the thermo roll is short, and it is possible to limit heat transfer more accurately to the web area and to limit heat transfer outside the web area.

A particularly essential feature of one embodiment of the invention is constituted by layered wholes arranged in layers radially one within the other in the shell of the thermo roll, according to the first embodiment of which wholes at least two material layers which are different in respect of their manufacturing technique have been arranged radially one within the other in the shell of the thermo roll, which material layers have been manufactured with respect to their manufacturing technique in different stages or by different methods, and there are heat transfer medium flow passages confined by at least one of said material layers inside itself or situated in a boundary zone of said material layers. The material of the layers of the shell which are different in respect of the manufacturing technique can then be, for example, chemically of the same conventional material, for example, advantageously steel.

The invention also makes it possible arrange the layers of the shell of the thermo roll in accordance with one embodiment in layers radially to form layered wholes one within the other, so that the thermal conductivities of at least two of the material layers are different from one another, and there are heat transfer medium flow passages in at least one of said material layers or confined by at least one of said material layers inside itself or situated in a boundary zone of said material layers.

In the surface of the thermo roll there can be a fairly thin material layer, for example, a steel shell which affords desired strength, toughness, hardness, wear resistance, surface quality or other similar properties and which may have lower thermal conductivity than that of the material layer serving as the heat transfer layer. In accordance with one embodiment of the invention, the material layer forming the outer surface of the roll shell of the thermo roll is sought to be kept thinner than the material layer serving as the heat transfer layer in order that the overall thermal conductivity of the roll shall not be lowered too much. Thus, the surface layer can be even very thin, for example, a chrome-plated layer or another hardcoating or ceramic layer if the material layer serving as the heat transfer layer inside it is sufficient in respect of its mechanical properties to withstand the stresses arising through nip load and the thermal stresses of the thermo roll in order that the possibly hard and brittle material layer forming the surface shall stick. Of course, the thermo roll in accordance with the invention can also be manufactured without the coating layer of the roll shell.

In the surface of the thermo roll there can be a fairly thin material layer, for example, a steel shell which affords desired strength, toughness, hardness, wear resistance, surface quality or other similar properties and which may have lower thermal conductivity than that of the material layer on the inner side of the surface layer, which material layer can serve as a special heat transfer layer since it is in respect of its material highly thermally conductive, but the thermal conductivity and/or the other material properties of the surface layer and the layer on the inner side of the surface layer can also be similar. If the outer surface of the roll shell of the thermo roll is formed by a thermally less conductive material layer, it is sought to be kept thinner than the material layer serving as the heat transfer layer in order that the overall thermal conductivity of the roll shall not be lowered too much.

With the thermo roll optimized in respect of its heat transfer properties in accordance with the invention, the working devices of the fibrous web making use of the thermo roll, in particular a calender, such as a multinip calender, a supercalender, a soft calender, a long nip calender and a belt calender or a metal belt calender, as well as a machine calender, a so-called “breaker stack” calender or an equivalent calender in a drying or finishing section of a fibrous web machine, and in particular an impulse press in a press section, a drying cylinder in a dryer section, and devices in connection with coating, in particular in the dry coating fixing process, can be designed for high heat capacities without needing to use other heating methods in addition to oil heating to raise the surface temperature of the thermo roll shell and to transfer desired heat capacity to the fibrous web that is being treated.

To the outer side or to the inner side of the layered wholes, i.e. layers, of the shell of the thermo roll, said wholes being layered in the sense of their manufacturing technique, it is possible to attach another layer of the same or similar material advantageously using different manufacturing techniques, when desired, in stages, for example, one layer at a time, for example, by hot isostatic pressing. Such layered structure of the thermo roll allows the layers of the shell to be controlled in a layer by layer fashion. Thus, a material that conducts heat well can be placed in the structure at a location where it is desirable to enhance heat transfer, a material that conducts heat poorly can be possibly placed in the structure at a location where it is desirable to retard heat transfer and, moreover, it becomes possible to place flow passages close to the surface of the shell, so that in accordance with one object of the invention the heat transfer distance can be reduced between the outer surface of the shell of the thermo roll and the heat transfer area, with a view to enhancing the transfer of heat capacity through the shell of the thermo roll to the nip and further to the fibrous web that is treated.

The present invention thus also relates to a thermo roll for manufacturing, in particular for finishing, a low-gloss and smooth fibrous web, the thermo roll being for manufacturing a low-gloss fibrous web, in particular for finishing by calendering in a device situated in a finishing line of a fibrous web machine, such as a multinip calender, a soft calender, a machine calender, a belt calender, a metal belt calender or in some combination of said calendars.

Matte paper and board products are low-gloss, smooth products which are often used in applications where a very high level of quality is required, for example as printing papers, art papers and photographic papers. An essential feature is low gloss, matte quality, of the surface, which nevertheless allows a high-quality and glossy printing result.

As known, high-quality matte paper can be manufactured by calendering paper by means of a porous and small-scale coarse roll provided with a ceramic coating. A ceramic coating roll is described, for example, in the published application FI 971542. One such ceramic coating is ValMatt by its trade name.

Since the surface of the roll is porous/coarse, paper does not become more glazed although linear load or temperature is raised, but rather the opposite it may be thought that the matte quality of the surface becomes more marked. On the other hand, smoothness and density increase, which is also necessary from the viewpoint of the printing result.

If it is desirable to increase production rate, the linear load and the temperature or the heat capacity of the calender must be increased in order to achieve smoothness. At high speeds, the heat transfer capacity of the thermo roll becomes a problem, which limits running speed in many calendering applications.

Different arrangements have been proposed to enhance heat transfer, one of which arrangements is, for example, a metal belt calender comprising a long heat transfer zone. FI patent application 20031230 discloses a thermo roll for enhancing heat transfer, the shell of which thermo roll is manufactured of a material that conducts heat well and which may comprise a ceramic coating. FI patent application 20031231 discloses a thermo roll for enhancing heat transfer, the shell of which thermo roll is provided with flow passages, and in FI patent applications 20031232 and 20031233 the shell of the thermo roll is manufactured of two different material layers. FI patent application 990691 discloses a thermo roll whose shell is manufactured using a powder metallurgical method.

A general object of the present invention is to reduce the weaknesses associated with the prior art and to provide a thermo roll with improved heat transfer properties and to provide a method using the thermo roll, by means of which thermo roll and method it is possible to manufacture low-gloss and smooth printing papers and board products advantageously and efficiently.

These objects are achieved by the present invention whose characteristic features are defined in the appended set of claims.

The thermo roll according to the invention is mainly characterized in that the thermo roll has been arranged in at least one nip which calenders the fibrous web and which is in the device situated in the finishing line of the fibrous web machine, that the heat transfer capacity of the thermo roll is 100-400 kW/m, that the distance of heat transfer medium flow passages in a shell of the thermo roll from the outer surface of the shell is <55 mm, and/or that the parts of the shell of the thermo roll significant with respect to heat transfer have been manufactured of a material which conducts heat well and whose thermal conductivity λ>70 W/mK.

The material of the thermo roll shell which conducts heat well may have been selected from a group including copper, tin, aluminum, zinc, chrome, zirconium or an equivalent metal material that conducts heat well or an alloy or a composition metal formed of at least two of these materials, such as CuCrZr.

The thermo roll may have been coated with a ceramic coating, such as the ValMatt coating.

The shell of the thermo roll may have been manufactured at least partly using powder metallurgy.

The surface of the thermo roll may be porous and coarse in its microstructure to produce a fibrous web of matte quality in calendering.

A method for manufacturing a low-gloss fibrous web, such as matte paper or matte board, in particular for finishing by calendering, in which method the thermo roll according to any embodiment of the invention is used, is characterized in that the fibrous web is calendered by means of the thermo roll in at least one nip in a multinip calender or a soft calender or a machine calender or a belt calender or a metal belt calender or in some combination of said calenders.

In the method the fibrous web may be calendered on the same calender as some other fibrous web grade such that said fibrous web is calendered by operating some of the nips using a smaller number of nips than when calendering other fibrous web grades, in particular glossy grades.

In the method the fibrous web may be calendered in a separate nip which is situated in a finishing line and in which there is a thermo roll according to the invention, and which nip can be used or not used when calendering other fibrous web grades, in particular glossy grades.

In the method the calendering of the fibrous web may be performed on an uncoated or coated fibrous web.

With respect to the other aspects, characteristic features and advantages of the invention, reference is made to the dependent claims of the set of claims and to the following special part of the description, which describes in detail, yet only by way of example, some embodiments of the invention considered to be advantageous and how they can be carried out.

In the following, the invention will be described by way of example by means of some of its advantageous embodiments with reference to the appended drawings.

### BRIEF DESCRIPTION OF THE DRAWINGS

FIG. 1 is a cross-sectional view of an embodiment of an uncoated thermo roll in accordance with the invention.

FIG. 2 is a cross-sectional view of an embodiment of a coated thermo roll in accordance with the invention.

FIG. 3 is a cross-sectional view of an embodiment of an uncoated thermo roll provided with peripheral passages in accordance with the invention.

FIG. 4 is a cross-sectional view of an embodiment of a coated thermo roll provided with peripheral passages in accordance with the invention.

FIG. 5 shows a thermo roll provided with a center passage and with an induction heater placed outside the shell in accordance with an embodiment of the invention.

FIG. 6 shows a thermo roll provided with a center passage and with an induction heater placed inside the shell in accordance with an embodiment of the invention.

FIG. 7 is a longitudinal sectional view of an embodiment of a thermo roll in accordance with the invention.

FIG. 8 is a cross-section of the thermo roll shown in FIG. 7.

FIG. 9 is a cross-sectional view of a thermo roll in accordance with another embodiment of the invention.

FIG. 10 illustrates layers and flow passages of a thermo roll shell that can be used in some embodiments of the invention.

FIG. 11 is a partial cross-sectional view of the grooved innermost layer of a thermo roll shell in accordance with a first advantageous embodiment of the invention.

FIG. 12 is a partial sectional view of the innermost layer of the shell shown in FIG. 11 and of a material layer that surrounds it and serves as a heat transfer layer.

FIG. 13 is a partial sectional view of the shell of the thermo roll optimized in respect of its heat transfer properties in accordance with the first embodiment of the invention and provided with flow passages for a heat transfer medium.

FIG. 14A shows a thermo roll assembled of parts and optimized in respect of its heat transfer properties in accordance with a second advantageous embodiment of the invention.

FIG. 14B shows flow passage shapes formed in the boundary surface of two mating parts.

FIG. 15 shows a thermo roll shell in accordance with a third embodiment of the invention.

FIG. 16 shows a thermo roll shell in accordance with a variant of the third embodiment of the invention.

FIG. 17 shows an example diagram of the temperature distribution in the shell of the thermo roll in accordance with the first embodiment of the invention.

### DESCRIPTION OF THE PREFERRED EMBODIMENTS

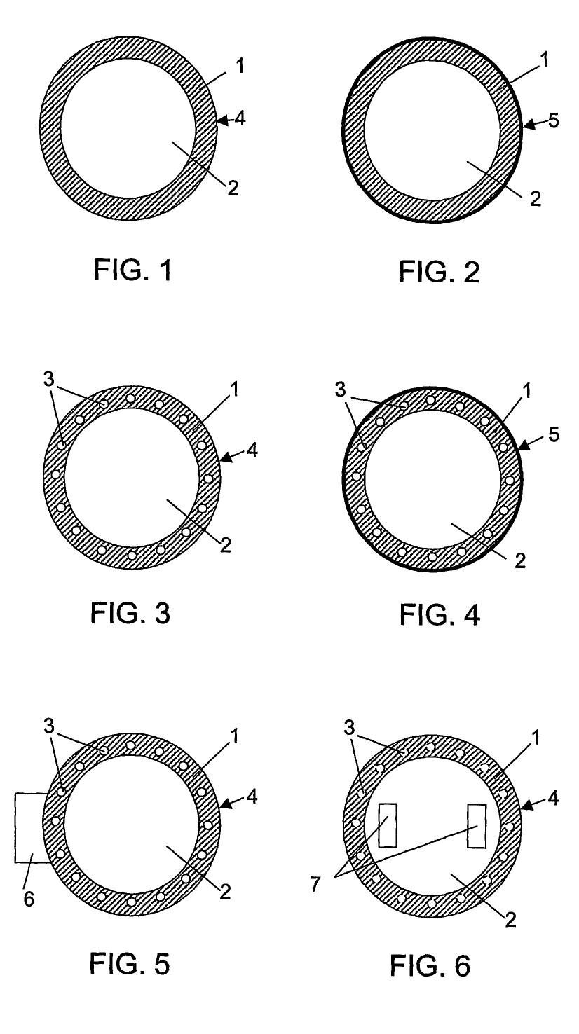

Reference is made to FIG. 1, which is a cross-sectional view of an embodiment of an uncoated thermo roll in accordance with the invention.

In the thermo roll of the embodiment shown in FIG. 1 there is a radially central bore or passage 2 for a heat transfer medium and a thermo roll shell which defines the central passage 2 and is formed in its entirety of a material layer 1 composed of one metal, the outer surface 4 of said material layer being, for the treatment of a fibrous web, in contact with said fibrous web.

In accordance with the invention, the thermal conductivity of the metallic material layer 1 is particularly good, which means that the thermal conductivity λ of the material layer 1>70 W/mK. Because of such a particularly good thermal conductivity, the roll has a high heat transfer capacity, even as high as 150-400 kW/m. It shall be noted, however, that in the fibrous web machines of the future, when an impulse dryer (see FIG. 5) and a long nip are associated with the thermo roll and when the running speeds of fibrous web machines increase, yet considerably higher heat transfer capacities, even as high as 500-800 kW/m, will be needed. In an application in accordance with one example of the invention where diameter is in a range of 1.0-1.5 m, the specific heat transfer capacity is then in a range of 30-260 kW/m2.

Reference is made to FIG. 2, which is a cross-sectional view of an embodiment of a coated thermo roll in accordance with the invention.

In the embodiment of FIG. 2, the thermo roll has a hardcoating, which improves the wear resistance of the roll and which is of graphite or a metallic hardcoating or the like. The thickness of the hardcoating is below 5 mm, typically 0.01-2 mm.

In the thermo roll of the embodiment of FIG. 2 there is a radially central bore or passage 2 for a heat transfer medium and a thermo roll shell which surrounds the central passage 2 and is formed by a material layer 1 composed of one metal and by a hardcoating placed on the material layer, the outer surface 5 of said hardcoating being, for the treatment of a fibrous web, directly in contact with said fibrous web.

The center passage 2 of the thermo roll thus serves as a flow passage for the heat transfer medium. This passage 2 can be provided with known devices that improve flow and heat transfer, such as a displacement part, flow guides or by shaping the surface of the center passage 2 suitably, for example, by roughening or grooving. The system of center passages can also be variable in the axial direction in its diameter or, more generally, in its cross-sectional flow area. It is generally necessary to enhance and control the flow in order that the heat flux passing through the roll shell should be even in the axial direction (CD direction).

In the embodiment of FIG. 2, in accordance with the invention, the thermal conductivity of the metallic material layer 1 is particularly good, which means that the thermal conductivity λ of the material layer 1>70 W/mK. Because of such a particularly good thermal conductivity, the roll has a high heat transfer capacity, even as high as 150-400 kW/m. It shall be noted, however, that in the fibrous web machines of the future, when an impulse dryer (see FIG. 5) and a long nip are associated with the thermo roll and when the running speeds of fibrous web machines increase, yet considerably higher heat transfer capacities, even as high as 500-800 kW/m, will be needed. In an application in accordance with one example of the invention where diameter is in a range of 1.0-1.5 m, the specific heat transfer capacity is then in a range of 30-260 kW/m².

Reference is made to FIG. 3, which is a cross-sectional view of an embodiment of an uncoated thermo roll provided with peripheral passages in accordance with the invention.

In the thermo roll of the embodiment of FIG. 3 there is a radially central bore or passage 2 for a heat transfer medium and a thermo roll shell which surrounds the central passage 2 and is formed in its entirety of a material layer 1 composed of one metal, the outer surface 4 of said material layer being, for the treatment of a fibrous web, directly in contact with said fibrous web.

In accordance with the invention, the thermal conductivity of the metallic material layer 1 is particularly good, which means that the thermal conductivity λ of the material layer 1>70 W/mK. Because of such a particularly good thermal conductivity, the roll has a high heat transfer capacity, even as high as 150-400 kW/m. It shall be noted, however, that in the fibrous web machines of the future, when an impulse dryer (see FIG. 5) and a long nip are associated with the thermo roll and when the running speeds of fibrous web machines increase, yet considerably higher heat transfer capacities, even as high as 500-800 kW/m, will be needed. In an application in accordance with an example of the invention where diameter is in a range of 1.0-1.5 m, the specific heat transfer capacity is then in a range of 30-260 kW/m².

To enhance the heat transfer properties, the material layer 1 of the thermo roll shell in the embodiment of FIG. 3 is provided with peripheral or shell passages 3 parallel to the axis of rotation or deviating from the direction of the axis of rotation of the thermo roll, through which passages a heat transfer medium can be passed in addition to the central bore or passage 2.

The peripheral passages 3 in accordance with the embodiment of FIG. 3 can be provided with devices that control flow and heat transfer, such as displacement parts or flow guides or by shaping the inner surface of the shell passages 3 suitably. The passages 3 can also be variable in the axial direction in their diameter or, more generally, in their cross-sectional flow area. It is generally necessary to enhance the flow in order that the heat flux passing obtained from the system of passages should be even in the axial direction (CD direction) of the roll.

The roll arrangements of FIGS. 3 and 4 can also be used so that the heat transfer medium is caused to flow only in the system of shell passages, as in the conventional thermo roll.

Reference is made to FIG. 4, which is a cross-sectional view of an embodiment of a coated thermo roll provided with peripheral passages in accordance with the invention.

In the embodiment of FIG. 4, the thermo roll has a hardcoating 5, which improves the wear resistance of the roll and which is of graphite or a metallic or ceramic hardcoating or the like. The thickness of the hardcoating is below 5 mm, typically 0.01-2 mm.

In the thermo roll of the embodiment of FIG. 4 there is a radially central bore or passage 2 for a heat transfer medium and a thermo roll shell which surrounds the central passage 2 and comprises a material layer 1 of one metal and the hardcoating placed on the material layer 1. For the treatment of a fibrous web, the outer surface 5 of the hardcoating is directly in contact with said fibrous web.

In the embodiment of FIG. 4, in accordance with the invention, the thermal conductivity of the metallic material layer 1 is particularly good, which means that the thermal conductivity λ of the material layer 1>70 W/mK. Because of such a particularly good thermal conductivity, the roll has a high heat transfer capacity, even as high as 150-400 kW/m. It shall be noted, however, that in the fibrous web machines of the future, when an impulse dryer (see FIG. 5) and a long nip are associated with the thermo roll and when the running speeds of fibrous web machines increase, yet considerably higher heat transfer capacities, even as high as 500-800 kW/m, will be needed. In an application in accordance with an example of the invention where roll diameter is in a range of 1.0-1.5 m, the specific heat transfer capacity is then in a range of 30-260 kW/m².

To enhance the heat transfer properties, the metallic material layer 1 of the thermo roll shell in the embodiment of FIG. 4 is provided with peripheral or shell passages 3 parallel to the axis of rotation or deviating from the direction of the axis of rotation of the thermo roll, through which passages a heat transfer medium can be passed in addition to the central bore or passage 2.

The methods known in themselves can be used as methods of manufacturing the shell part of the roll in accordance with the invention. The roll can be manufactured either entirely or partly by powder metallurgical means, as disclosed in FI patent 106054, using methods of casting technology, by cutting and forging methods.

The end and the shaft parts of the roll in accordance with the invention can be manufactured by the same known methods as those used for the shell part. The end parts can be manufactured of the same material as the shell, but particularly advantageously they are manufactured out of a metal that withstands loads well, such as steel.

To facilitate the machining of the peripheral passages 3, it is advantageous that the thermo roll is composed of parts in the direction of the axis of rotation of the thermo roll, so that the thermo roll is composed of roll sections provided with axial or spirally extending passages formed, for example, by drilling, which passages form peripheral passages extending over the entire length or a selectable length/part of the thermo roll when roll sections are disposed one after another. Particularly advantageously, the roll shell is manufactured by powder metallurgical methods, as known, for example, from FI patent 106054, in which case the system of peripheral passages can be manufactured in connection with the manufacture of the shell.

Reference is made to FIG. 5, which shows a thermo roll provided with a center passage and with an induction heater placed outside the shell in accordance with an embodiment of the invention.

In the thermo roll of the embodiment of FIG. 5 there is a radially central bore or passage 2 for a heat transfer medium and a thermo roll shell which surrounds the central passage 2 and is formed of a material layer 1 composed in its entirety of one metal, the outer surface 4 of said material layer being, for the treatment of a fibrous web, directly in contact with said fibrous web.

In the embodiment of FIG. 5, in accordance with the invention, the thermal conductivity of the metallic material layer 1 is particularly good, which means that the thermal conductivity λ of the material layer 1>70 W/mK. Because of such a particularly good thermal conductivity, the roll has a high heat transfer capacity, even as high as 150-400 kW/m. It shall be noted, however, that in the fibrous web machines of the future, when an impulse dryer and a long nip are associated with the thermo roll and when the running speeds of fibrous web machines increase, yet considerably higher heat transfer capacities, even as high as 500-800 kW/m, will be needed. In an application in accordance with an example of the invention where roll diameter is in a range of 1.0-1.5 m, the specific heat transfer capacity is then in a range of 30-260 kW/m².

To enhance the heat transfer properties, the metallic material layer 1 of the shell of the thermo roll in the embodiment of FIG. 5 is provided with peripheral or shell passages 3 parallel to the axis of rotation or deviating from the direction of the axis of rotation of the thermo roll, which passages may be arranged when needed, but not necessarily, and through which passages a heat transfer medium can be passed in addition to the central bore or passage 2. It is particularly advantageous to use peripheral passages for the cooling of the roll in connection with induction heating when it is desirable to cool the roll shell quickly in a controlled manner, for example, when a service shutdown becomes necessary. In addition, the thermo roll in accordance with the embodiment of FIG. 5 is provided with an external induction heater 6, which acts directly on the outer surface 4 of the thermo roll shell. It shall be noted that the induction heater can also be disposed as an internal induction heater of the thermo roll, for instance, as shown in FIG. 6, and that an induction heater/induction heaters can be disposed both inside and outside the thermo roll.

To facilitate the machining of the peripheral passages 3, it is advantageous that the thermo roll is composed of parts in the direction of the axis of rotation of the thermo roll, so that the thermo roll can be composed of roll sections provided with axial or spiral passages formed, for example, by drilling, which passages form peripheral passages 3 extending over the entire length or a selectable length/part of the thermo roll when roll sections are disposed one after another. Advantageously, the roll shell can also be manufactured by powder metallurgical means, in which case the flow medium passages can be formed in connection with the manufacture of the shell part.

Reference is made to FIG. 6, which shows a thermo roll provided with a center passage and with an induction heater placed inside the shell in accordance with an embodiment of the invention.

In the thermo roll of the embodiment of FIG. 6 there is a radially central bore or passage 2 for a heat transfer medium and a thermo roll shell which surrounds the central passage 2 and is formed of a material layer 1 composed in its entirety of one metal, the outer surface 4 of said material layer being, for the treatment of a fibrous web, directly in contact with said fibrous web.

In the embodiment of FIG. 6, in accordance with the invention, the thermal conductivity of the metallic material layer 1 is particularly good, which means that the thermal conductivity λ of the material layer 1>70 W/mK. Because of such a particularly good thermal conductivity, the roll has a high heat transfer capacity, even as high as 150-400 kW/m. It shall be noted, however, that in the fibrous web machines of the future, when an impulse dryer and a long nip are associated with the thermo roll and when the running speeds of fibrous web machines increase, yet considerably higher heat transfer capacities, even as high as 500-800 kW/m, will be needed. In an application in accordance with an example of the invention where roll diameter is in a range of 1.0-1.5 m, the specific heat transfer capacity is then in a range of 30-260 kW/m².

To enhance the heat transfer properties, the metallic material layer 1 of the shell of the thermo roll in the embodiment of FIG. 6 is provided with peripheral or shell passages 3 parallel to the axis of rotation or deviating from the direction of the axis of rotation of the thermo roll, which passages may be arranged, as shown with broken lines in FIG. 6, when needed, but not necessarily arranged, and through which passages a heat transfer medium can be passed in addition to the central bore or passage 2. It is particularly advantageous to use peripheral passages for the cooling of the roll in connection with induction heating when it is desirable to cool the roll shell quickly in a controlled manner, for example, when a service shutdown becomes necessary. In addition, the thermo roll in accordance with the embodiment of FIG. 6 is provided with an internal induction heater 7, which acts on the shell of the thermo roll.

By way of example, it can be stated as specific values achievable in a thermo roll of a calender in accordance with one exemplifying embodiment:

| | |
|---|---|
| diameter advantageously | 1500 mm, it can be e.g. 0.8-2 m |
| shell thickness advantageously | 100 mm, it can be 50-250 mm |
| oil temperature advantageously | 300° C., it can be 100-400° C. |
| roll surface temperature | 250° C., it can be 100-380° C. |
| heat capacity (to the web) | 250 kW/m, it can be 150-400 kW/m |
| specific heat capacity | 53 kW/m², it can be 24-260 |
| | kW/m². |

By way of example, it can be stated as specific values achievable in a thermo roll of a press or an impulse press in accordance with another exemplifying embodiment:

| | |
|---|---|
| diameter advantageously | 1500 mm, it can be e.g. 0.8-2 m |
| shell thickness advantageously | 100 mm, it can be 50-250 mm |
| oil temperature | 50-400° C. |
| roll surface temperature | 50-380° C. |
| heat capacity (to the web) | 150-800 kW/m |
| specific heat capacity | 24-320 kW/m². |

The coating layer possibly used in the arrangement in accordance with the invention can be, for example, a graphite, metal or ceramic hardcoating, whose thickness is less than 5 mm, advantageously 0.01-2 mm and particularly advantageously 0.01-0.5 mm. The coating can be a hard chrome plating, a thermally sprayed coating (e.g. HVOF) or a coating made by a coating welding or laser coating method.

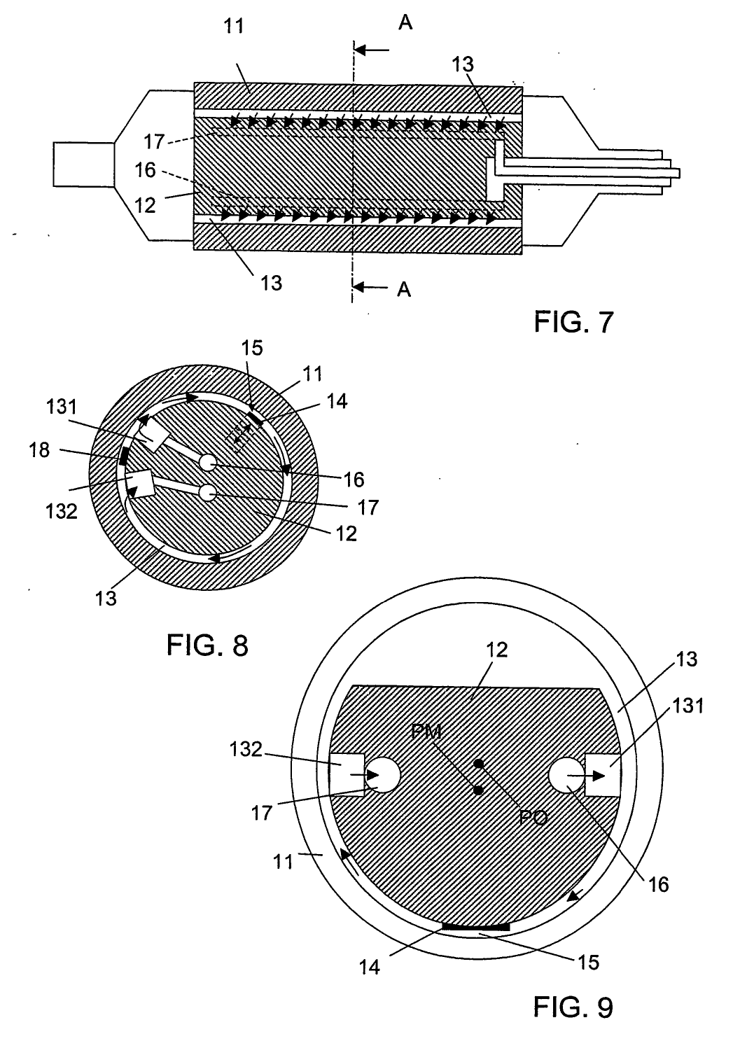

Reference is made to FIG. 7. The figure is a longitudinal sectional view of a thermo roll in accordance with an embodiment of the invention. The thermo roll includes a rotating shell 11 and a roll body 12, which is non-revolving or rotating with a rotary motion at least substantially differing from the speed of the rotary motion of the shell, so that the opposing surfaces defining a gap between the roll body 12 and the shell 11 have a clear speed difference.

The thermo roll is provided with at least one flow passage 13 for a heat transfer medium between the roll body 12 and the shell 11 in the longitudinal and circumferential direction of the roll body 12. The heat transfer medium is passed into the flow passage 13 from a distribution passage/passages 16, whose inlet duct is at the end of the thermo roll, substantially simultaneously across the entire width of the thermo roll, and the heat transfer medium is removed from the flow passage into a heat transfer medium discharge passage 17, whose discharge duct is also at the end of the thermo roll, substantially simultaneously across the entire width of the thermo roll.

Reference is made to FIGS. 8 and 9. A heat transfer medium is passed into the flow passage 13 by heat transfer medium supply means, which include the distribution passage/passages 16 and an inlet/inlets 131 connected to said distribution passage/passages, as well as the discharge passage/passages 17 and an outlet/outlets 132 connected to said discharge passage/passages. The heat transfer medium is passed into the flow passage 13 from at least one distribution passage 16 through at least one heat transfer medium inlet 131 and the heat transfer medium is removed from the flow passage 13 into at least one discharge passage 17 through at least one heat transfer medium outlet 132. In the flow portion between the distribution passage/passages 16 and the flow passage 13 and/or in the flow portion between the flow passage 13 and the discharge passage/passages 17 there can be position-specific valves or other similar throttling means in the axial direction of the thermo roll to control the flow and/or the temperature of the heat transfer medium in the flow passage 13. The shaping of the inlet 131 and/or the outlet 132 is not essential to the present invention, but different passage designs can be used for connecting the flow passage 13 into flow communication with the distribution passage 16 and/or the discharge passage 17.

It is characteristic of the invention that the flow of the heat transfer medium in the flow passage 13 can be controlled by a flow control means 14. Since both the introduction and the removal of the hot heating medium takes place across the entire width of the roll, significant temperature differences cannot be created in the axial direction of the thermo roll or it is at least easier to control temperature differences. In accordance with the arrangement of the invention, the flow of the heat transfer medium is arranged to pass in a flow gap 15 of the flow passage 13 between the shell 11 and the body 12, in which flow gap there can be a special displacement part, substantially in the circumferential direction of the roll instead of the flow passing in the flow gap in the axial direction. The above-mentioned displacement part is, for example, the flow control means 14 shown in FIGS. 8 and 9. The flow in the circumferential direction of the thermo roll provides the advantage that the oil that is cooling while it flows does not cause temperature differences in the axial direction of the thermo roll. The entry and exit openings of the flow medium, i.e. the inlet openings 131 and the outlet openings 132 of the flow medium, are arranged in connection with the center part, i.e. the body 12, of the thermo roll, substantially across the entire width of the thermo roll. Then, by controlling the flow and/or the temperature of the heat transfer medium in the flow passage 13, the surface temperature of the shell 11 is controlled over the entire length of the thermo roll either evenly or variably in a controlled manner. This allows the fibrous web to be profiled by means of the heating of the shell.

It shall be noted that the flow can also take place in the passage 13 without the separate flow gap 15 being shaped by means of the separate control means 14, in which case the flow system is determined merely by the shaping of the walls of the body part 12 and the shell. The shaping of the walls, in particular in respect of the body part 12, can be selected in a manner satisfactory with respect to the flow, yet achieving a simple structure.

A profiling effect is achieved in accordance with one embodiment of the invention by adjusting, in addition to the height of the flow passage 13, i.e. the flow gap 15, also the length of the flow passage 13. In accordance with the invention, the flow gap 15 is generally defined between the inner surface of the shell 11 and the outer surface of the body 12. In particular, the throttled part of the flow gap is formed between the shell 11 and the peripheral surface of the flow control means 14 directed towards the shell 11. Since the control means 14 is movable, it becomes possible to adjust the height of the flow gap 15, even to close it. It may be further contemplated that several control means are arranged successively in the circumferential direction, or their throttling effect can be otherwise continued in the flow direction, so that in the advantageous embodiments shown in FIGS. 8 and 9, for the purpose of adjusting the height and/or the length of the flow gap 15, i.e. the flow in the gap, each control means 14 is formed by a block element, i.e. profiling block 14, which is axially position-specific and arranged in the roll body 12 and which manipulates the flow gap in the radial, circumferential or axial direction. Alternatively, the flow control means 14 of the heat transfer medium, which adjusts the height and/or the length of the flow gap 15 in the flow passage 13 of the heat transfer medium and which enables the fibrous web to the profiled, is, for example, an articulated projection part (not shown in the figures), i.e. a profiling part, arranged in the profiling block and movable in the radial or circumferential direction.

Generally, the flow control means 14 of the heat transfer medium, i.e. the profiling part, which adjusts the height and/or length of the flow gap 15 in the flow passage 13 of the heat transfer medium and which enables the fibrous web to the profiled, is a heat transfer medium flow throttling and/or displacement part 14 which is movable or which changes its shape and by means of which at least the height of the flow gap 15 of the flow passage 13 and/or the length of the flow passage 13 can be adjusted.

In an advantageous embodiment of the invention, the control of the flow of the heat transfer medium in the flow passage between the roll body 12 and the shell 11 is accomplished by means of the throttling and/or displacement part 14. At least one throttling and/or displacement part 14 is arranged in the flow passage successively both in the longitudinal and in the circumferential direction of the roll body 12. Each throttling and/or displacement part forms, in the radial direction between itself and the shell 11, one or more flow gaps 15, whose gap distance is 1-50 mm, advantageously about 5-25 mm.

This gap distance as well as the length of the flow gap 15 are dimensioned, based on heat transfer calculations, to be sufficiently long in the circumferential direction. Advantageously, the flow gap is, however, effective in a portion of over 20% of the length of the inner circumference. The function of the flow gap 15 is to accelerate the flow of the heat transfer medium so that a highly turbulent and mixing flow is created most advantageously, so that heat transfer from the gap flow to the inner surface of the roll shell 11 is efficient.

In accordance with the invention, it is recommendable in particular for providing a turbulent and mixing flow that the profiling part form a straight-faced and acute-angled flow obstruction in the flow passage and that the profile of the profiling part in the rotation direction of the thermo roll advantageously conform to the profile of the respective area in the opposing part of the flow gap 15. When the profiling part, i.e. the displacement part 14, is additionally movable in the flow passage 13 in the radial and/or circumferential direction in accordance with the invention, the gap distance of the flow gap 15 of the flow passage 13 can be adjusted to generate a highly turbulent and mixing flow of the heat transfer medium, which enhances heat transfer from the heat transfer medium to the shell 11. The turbulence of the heat transfer medium flow can be enhanced further, for example, by at least partial grooving, rough shaping or another kind of shaping of the inner surface of the shell 11 and/or the outer surface of the roll body 12, which enhances the turbulence of the flow.

By arranging the inlet openings 131 and the outlet openings 132 of the heat transfer flow medium, for example, as shown in FIG. 8 and by disposing a suitable throttling means or an obstruction part 18 between these openings in the flow passage 13 such that the throttling means/obstruction part 18 throttles a considerable part of the flow passage 13 between the outer surface of the body 12 and the inner surface of the shell 11 (or closes it altogether), the relative rotary motion of the shell 11 and the body 12 of the roll produces a significant pumping effect, for which energy is taken from the rotary motion of the shell 11. The throttling means 18, which is placed between the inlet openings 131 and the outlet openings 132 and which can be adjustable, for example, movable in the radial direction of the roll, enhances the pressure difference in the flowing heat transfer medium. The need for separate pumping is reduced and a large through flow is achieved, which means a high heat transfer capacity. Thus, the thermo roll itself functions as a pump. Moreover, the pumping effect is enhanced with increasing speed, precisely when more capacity is also needed.

Reference is made to FIG. 9. In many cases, the body 12 is fitted to be stationary. In the embodiment of the figure, the body 12 is rotating, for example, the body 12 is journalled at its ends. The free rotation of this kind of body 12 around the central axis of rotation PO is prevented or retarded by the center of mass PM arranged to be offset from the geometric center axis PO of the body 12 in accordance with the invention, i.e. the body 12 is eccentric.

A roll body 12 that is movable with respect to the thermo roll shell 11 is also feasible. It is thus possible to adjust the height, i.e. the gap distance, of the flow gap 15 of the flow passage 13, for example, mechanically either by moving the thermo roll body 12 with respect to the shell 11 or by bending or by adjusting the shape or size of the thermo roll body 12 or by adjusting a separate actuating means connected to the body 12. Further, the body part 12 which is inside the roll shell and which controls and displaces the flow can be as a whole or partly adjustable in size or shape without needing a separate movable actuating member 14 for adjusting the gap distance in the flow passage.

Since the shell 11 rotates, this inner surface of the shell 11 “draws” some of the flow with it and since the center part 12 is totally or almost static, the outer surface of the center part 12 slows down the flow. In that connection the flow velocity on the inner surface of the roll shell 11 and the flow velocity on the outer surface of the body 12 differ substantially from each other, so that a very strong shear field is created in the gap flow of the flow gap 15 because of the great differences in the flow velocities. Because of shear, the flow and heat transfer boundary layers become thinner and turbulence is generated more easily and heat transfer is improved. The flow of the heat transfer medium in the circumferential direction of the thermo roll in the flow gap 15 of the flow passage 13 tends to rotate the body 12 of the thermo roll, but this is cancelled in accordance with one embodiment of the invention either by arranging an eccentric center of mass PM in the body 12 or by means of fixed support of the body 12. In that case, the body 12 journalled to be rotating remains non-revolving or rotates substantially more slowly than the shell 11.

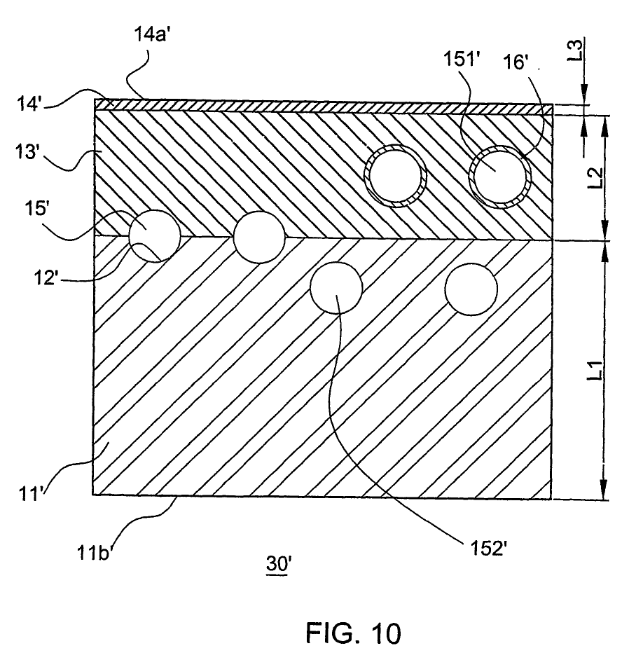

FIGS. 10-17 illustrate a thermo roll 10′, 20′, 101′ which is used for the treatment of a fibrous web and provided with heat transfer means arranged inside a shell, thus being heatable or coolable on the inside, advantageously by means of a heat transfer medium. The shell of the thermo roll 10′, 20′, 101′ comprises at least two, in some embodiments three material layers 11′, 13′, 14′, 21′, 23′, 24′. The surface 14a′, 24a′ of the outermost material layer is in contact with the fibrous web or a wire.

The thermo roll 10′, 20′, 101′ optimized in respect of its heat transfer properties in accordance with the invention is composed of one part or of several roll sections in the axial direction. At least two, in some embodiments advantageously three material layers 11′, 13′, 14′, 21′, 23′, 24′ are arranged radially one within the other in the shell of the thermo roll 10′, 20′, 101′.

In accordance with a first embodiment of the invention, at least two different material layers 11′, 13′, 14′, 21′, 23′, 24′ are arranged, using a manufacturing technique, radially one within the other in the shell of the thermo roll, which material layers have been manufactured with respect to their manufacturing technique in different stages or by different methods, so that in accordance with one embodiment the thermal conductivity of each material layer in the shell of the thermo roll is in a range of 20-70 W/mK.

In accordance with a second embodiment of the invention, material layers 11′, 13′, 14′, 21′, 23′, 24′ are arranged radially one within the other in the shell of the thermo roll, the thermal conductivities of at least two material layers being different from one another, so that in accordance with one embodiment at least one of said material layers, the thermal conductivities of which are different from one another, is a heat transfer layer 13′, 23′, which is of a metal material that conducts heat particularly well, the effective thermal conductivity λ of the thermo roll across the shell of the thermo roll being >70 W/mK.

In addition, there are heat transfer medium flow passages 15′, 25′, 30′, 151′, 152′ in at least one material layer 11′, 13′, 14′, 21′, 23′, 24′ or in a material layer 11′, 13′, 14′, 21′, 23′, 24′ manufactured in stages or in layers or assembled in stages or in layers or confined by at least one material layer inside itself or in a boundary zone of two material layers.

In accordance with one advantageous embodiment of the invention, the thermo roll comprises a system of heat transfer medium flow passages 15′, 25′, 151′, 152′ such that the heat transfer distance between the outer surface 14a′, 24a′ of the surface layer 14′, 24′ of the shell and the system of flow passages of the thermo roll is arranged to be short such that at least some of the flow passages are placed, measured at their center line, advantageously at a distance of 50 mm at the most, more advantageously at a distance of 10-40 mm from the outer surface of the thermo roll.

To enhance the even distribution of heat transfer and heat, the thermo roll 10′, 20′, 101′ comprises heat transfer means for heat transfer.
As shown in FIGS. 10-14B, the heat transfer means include a material layer which is arranged between the inner layer 11′, 21′ of the thermo roll 10′, 20′ and the surface layer 14′, 24′ in contact with the fibrous web and which forms a heat transfer layer 13′, 23′, which in accordance with one embodiment of the invention is of a material whose thermal conductivity is higher than the thermal conductivity of the inner layer 11′, 21′. In accordance with one embodiment of the invention, the material of the heat transfer layer 13′, 23′ is advantageously a material that conducts heat particularly well and has an effective thermal conductivity of >70 W/mK.
As shown in FIG. 15, the heat transfer means include a material layer which is arranged to form the innermost layer of the thermo roll 101′ and which forms a heat transfer layer 13′, which in accordance with one embodiment of the invention is of a material whose thermal conductivity is higher than the thermal conductivity of the surface layer 14′ in contact with the fibrous web and surrounding the heat transfer layer 13′. The material of this material layer serving as the heat transfer layer 13′ can be a material that conducts heat particularly well and has an effective thermal conductivity of >70 W/mK.
As shown in FIG. 16, the heat transfer means include a material layer of the thermo roll 101′, which material layer is thermally more conductive and forms a heat transfer layer 13′ whose material in accordance with one embodiment of the invention is a material that conducts heat particularly well and has an effective thermal conductivity of >70 W/mK, which material layer is outside the innermost layer 11′ that is thermally less conductive. The material of the innermost layer 11′ has been selected optimally with respect to internal induction heating.

The layer 13′, 23′ that conducts heat particularly well can be manufactured, for example, of copper or a copper alloy, such as, for example, CuCrZr. As the material of the heat transfer layer 13′, 23′ it is also possible to use brass, tin, aluminum, zinc, chrome, zirconium, nickel, steel or the like. The material of the heat transfer layer can also be an alloy or a composition metal containing above-mentioned metals.

To enhance the even distribution of heat transfer and heat, the thermo roll 10′, 20′, 101′ comprises heat transfer means for heat transfer, which heat transfer means include those layers which affect heat transfer and are situated even partly between the heat transfer medium flow passages and the outer surface of the thermo roll.
As shown in FIGS. 10-14B, the heat transfer means include a material layer 13′, 23′ which is arranged between the inner layer 11′, 21′ of the thermo roll 10′, 20′ and the surface layer 14′, 24′ in contact with the fibrous web and which in accordance with one embodiment of the invention is of a material whose thermal conductivity is higher than the thermal conductivity of the inner layer 11′, 21′. In accordance with one embodiment of the invention, the material of the layer 13′, 23′ on the inner side of the surface layer is a material that conducts heat particularly well and has an effective thermal conductivity of >70 W/mK. The thermal conductivity and/or the other material properties of the surface layer and the layer on the inner side of the surface layer can also be similar, so that the surface layer 14′, 24′ on the outer side and the layer 13′, 23′ on the inner side of the surface layer—constituting layered wholes in the sense of the manufacturing technique—may have the same material properties, so that in accordance with one embodiment the thermal conductivity of the material layers of the thermo roll shell is in a range of 20-70 W/mK.
As shown in FIG. 15, the heat transfer means include a material layer 13′ which is arranged to form the innermost layer of the thermo roll 101′ and which in accordance with one embodiment of the invention is of a material whose thermal conductivity is higher than the thermal conductivity of the surface layer 14′ in contact with the fibrous web and surrounding the heat transfer layer 13′. The material of this material layer serving as the heat transfer layer 13′ can be a material that conducts heat particularly well and has an effective thermal conductivity of >70 W/mK.
As shown in FIG. 16, the heat transfer means include a material layer 13′ of the thermo roll 101′, which material layer is thermally more conductive and forms a heat transfer layer 13′ whose material in accordance with one embodiment of the invention is a material that conducts heat particularly well and has an effective thermal conductivity of >70 W/mK, which material layer is outside the innermost layer 11′ that is thermally less conductive. The material of the innermost layer 11′ has been selected optimally with respect to internal induction heating.
   In accordance with one embodiment of the invention, the layer 13′, 23′ that conducts heat particularly well can be manufactured, for example, of copper or a copper alloy, such as, for example, CuCrZr. As the material of the heat transfer layer 13′, 23′ it is also possible to use brass, tin, aluminum, zinc, chrome, zirconium, nickel, steel or the like. The material of the heat transfer layer can also be an alloy or a composition metal containing above-mentioned metals. The material of the heat transfer layer can thus be a conventional material, such as steel.

Said heat transfer means also include flow passages in which a heat transfer medium, such as oil, water, steam, air or another similar flowing gaseous or liquid heat transfer medium is flowing. The heat transfer means arranged in accordance with the invention serve to enhance heat transfer from the flowing medium to the outer surface 14a′, 24a′ of the thermo roll in the case of heating of the thermo roll and, correspondingly, they serve to enhance heat transfer from the thermo roll to the flowing medium in the case of cooling of the thermo roll. Heat is transferred to the thermo roll and/or from the thermo roll using the heat transfer medium through flow passages 15′, 25′, 151′, 152′ situated inside the shell or through a center passage 30′ of the thermo roll or, alternatively, advantageously through both the center passage 30′ of the thermo roll and the flow passages 15′, 25′, 151′, 152′ situated inside the shell.

In particular in connection with the heating and cooling stages of the thermo roll, for example, when there is a transition from the running state to the servicing state or vice versa, it is advantageous to heat/cool the thermo roll through the shell passages and the center passage in order that the thermal stresses in the thermo roll shall not become too great. When the thermo roll is heated/cooled only through the shell passages, which are situated in the material layer having good thermal conductivity or in its immediate vicinity, the thermal stresses of the thermo roll may rise to too high a level as the change in temperature is directed to a substantial extent to said material layer, which functions as a heat transfer layer. During the heating or cooling of the thermo roll it is advantageous to use a separate heat transfer passage system in a thermally less conductive material layer situated on the inner side or on the outer side of the material layer that functions as the heat transfer layer to even out the temperature difference inside the thermo roll such that the thermal stresses remain in a range that causes no fatigue in the structure. Heat can also be produced for the interior parts of the thermo roll in other ways, for example, by internal induction heating, so that cooling can be accomplished, as mentioned above, by means of the heat transfer medium flowing in the flow passages. It is also possible to heat the thermo roll 10′, 20′, 101′ by hot air blowing.

The shell structure of the thermo roll 10′, 20′, 101′ in accordance with the invention is such that the properties of the material, in particular thermal conductivity and mechanical strength, are designed to change in a layer by layer fashion in the radial direction of the thermo roll 10′, 20′, 101′ to improve the operating characteristics of the thermo roll. Since it is generally not possible to achieve the optimum with respect to thermal conductivity and mechanical strength simultaneously with the same material, in accordance with the arrangement of the invention a material having the best property in view of the whole is selected for each area in the radial periphery of the thermo roll 10′, 20′, 101′.

FIG. 10 illustrates typical different material layers of the shell of the thermo roll in accordance with one embodiment of the invention and the location of flow passages or how it is possible to place them in the shell of the thermo roll. Instead of the three layers shown, the thermo roll in accordance with the invention may also comprise more layers, for example, four layers, or two layers as shown in FIG. 15. Depending on the embodiment of the invention, a given material layer can have the function of a mainly load-bearing layer or the function of a mainly heat-transferring layer or a given material layer can have the functions of both a load-bearing layer and a heat-transferring layer.

In the example of FIG. 10, the inner layer 11′ functioning as the base layer of the thermo roll is formed of a load-bearing material layer 11′. The function of the material layer arranged around the inner layer 11′ and forming a heat transfer layer 13′ is to transfer efficiently the heat capacity introduced by means of the heat transfer medium flowing into the thermo roll to the surface layer 14′ of the thermo roll and to the outer surface 14a′ of the thermo roll shell. There can be flow passages at several different levels and the thermo roll may have flow passages situated in different layers inside the shell, such as the flow passages 15′, 151′, 152′ and the center passage 30′ inside the thermo roll shell.

In the left-hand portion of the cross section of principle of the thermo roll shown in FIG. 10, there are two adjacent flow passages 15′ in the area of the boundary surface where the inner layer 11′ and the heat transfer layer 13′ of the shell of the thermo roll join each other, i.e. in the area of their boundary zone, which flow passages extend partly to the heat transfer layer 13′ and partly to the inner layer 11′. In that case, the flow passage is formed by recesses or grooves 12′ situated in opposed relationship in the outer surface of the inner layer and in the inner surface of the outer layer.

The thermo roll may also be provided with flow passages 151′ like the ones shown in the right-hand portion of the cross section of FIG. 10 and substantially placed in the heat transfer layer, which flow passages are in this example entirely inside the heat transfer layer 13′ or the layer 13′ on the inner side of the surface layer, entirely surrounded by the heat transfer material.

The thermo roll may also be provided with flow passages that are inside or outside a thermally highly conductive material layer or the heat transfer layer. In the example of FIG. 10, a flow passage 152′ is in its entirety in the inner layer 11′ surrounded by the heat transfer layer 13′, inside the heat transfer layer 13′, the flow passage 152′ being formed, for example, by a bore made in the inner layer 11′. The flow passage can also be equally well in its entirety in the surface layer surrounding the heat transfer layer, outside the heat transfer layer, the flow passage being formed, for example, by a bore made in the surface layer.

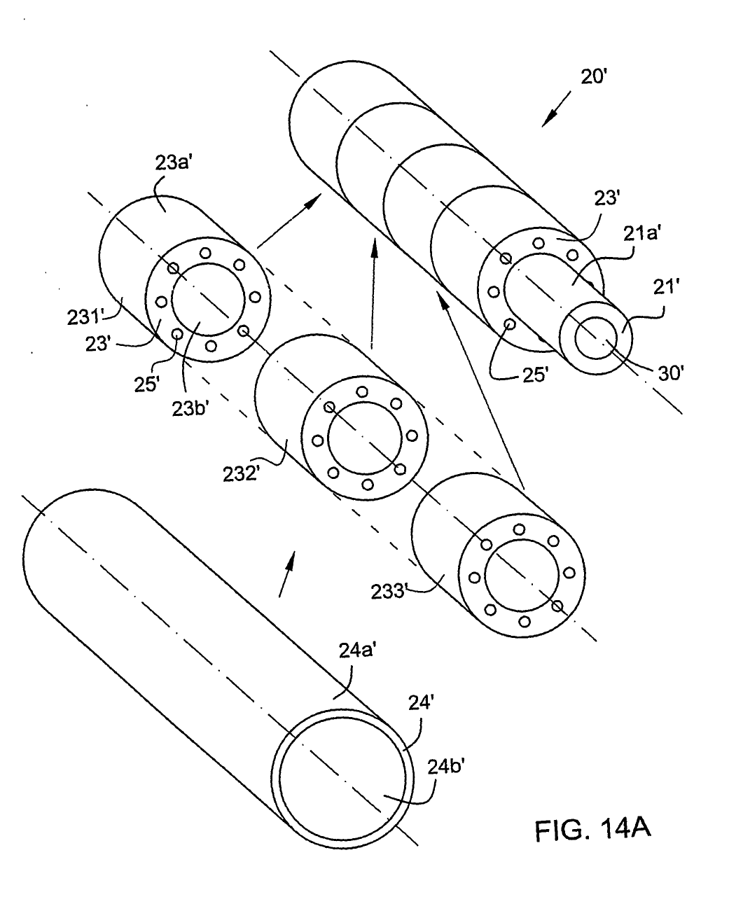

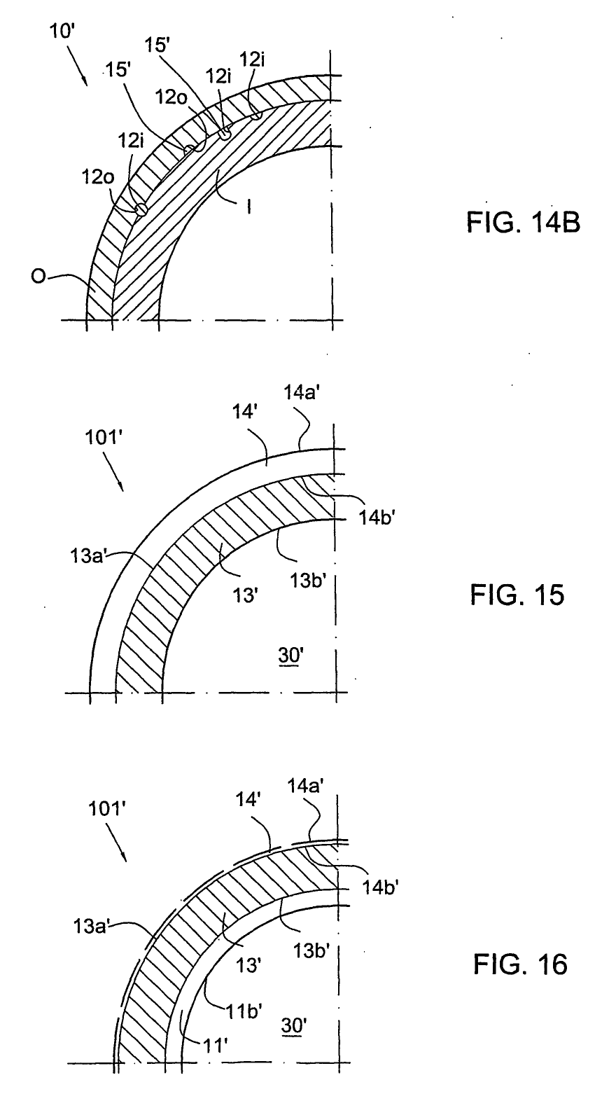

More generally, FIG. 14B shows, by means of four flow passages 15′, flow passage shapes formed in the boundary surface of two mating parts that form the thermo roll 10′. As shown in FIG. 14B, the flow passage 15′ can be formed in its entirety by a recess or a groove 12i made in the outer surface of the inner layer I, the depth of which recess or groove 12i from the outer surface of the layer I in the radial direction of the thermo roll can be selected to be suitable, for example, when arranging the heat transfer area of the flow passage to be as desired or when arranging the flow velocity of the heat transfer medium to be as desired, or the flow passage 15′ can be formed in its entirety by a recess or a groove 12o made in the inner surface of the outer layer O, the depth of which recess of groove 12o from the inner surface of the layer O can be selected to be suitable, or the flow passage 15′ can be formed of partly or totally coincident flow grooves 12i, 12o situated both in the inner layer I and in the outer layer O.

The flow passages can be provided, in accordance with the example of FIG. 10, with flow tubes 16′ either by providing the flow passages with tubes afterwards or by placing flow tubes 16′ inside the heat transfer layer 13′, inside another layer of the shell or inside a flow passage 15′, 151′, 152′ formed in the boundary zone of two layers in connection with manufacture, e.g. hot pressing. Thus, the flow passages 15′ placed in the shell of the thermo roll radially at a selectable distance from the outer surface of the thermo roll can be provided with tubes, as the flow passages 152′. The placement of the flow passages 15′, 151′, 152′ can be accomplished in accordance with the invention in different ways as described hereafter. The measurements of the material layers and the measurements and the placement density of the flow passages are determined, among other things, by the material arrangement to be chosen and by the heat capacity to be transferred in each site of use.

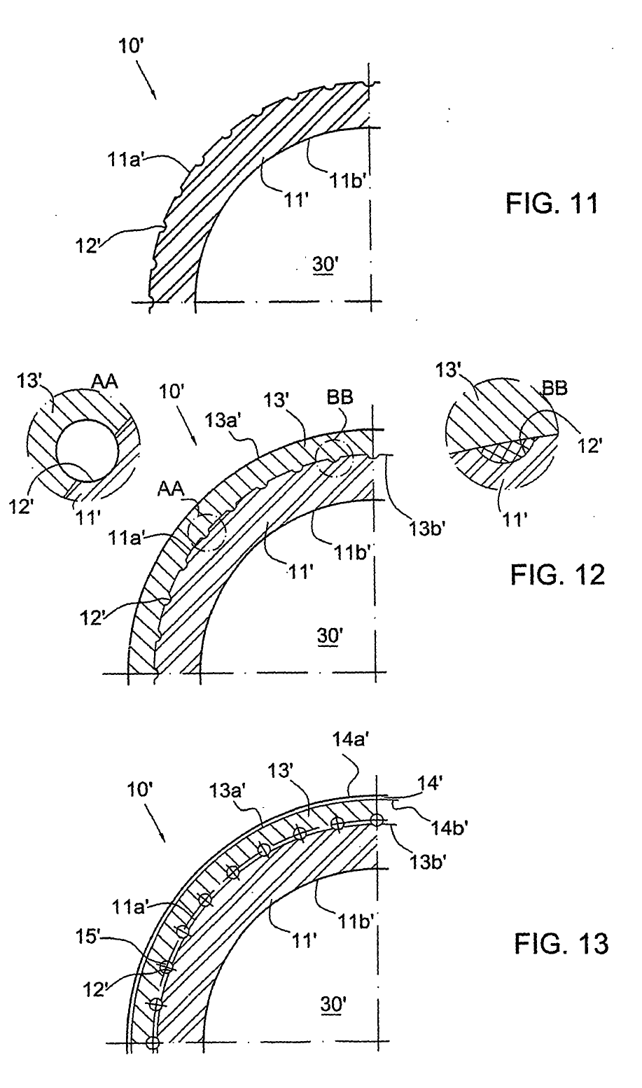

FIGS. 11-13 are a figure series of a first advantageous embodiment of the invention, in which the thermo roll 10′ is formed of three layers which are placed one upon the other and which are or may be of different materials. The structure of the shell of the thermo roll 10′ is such that the properties of the material, in particular thermal conductivity and mechanical strength, are designed to change in a layer by layer fashion in the radial direction of the thermo roll 10′ to improve the operating characteristics of the thermo roll. Since it is generally not possible to achieve the optimum with respect to thermal conductivity and mechanical strength simultaneously with the same material, in accordance with the arrangement of the invention a material having the best property in view of the whole is selected for each layer of the multi-layer thermo roll 10′.

As shown in FIG. 11, the inner layer 11′ functioning as the base layer of the thermo roll 10′ is thus formed of a solid load-bearing material layer 11′, which is in this example a relatively stiff, advantageously tubular part 11′. The inner surface 11b′ of the inner layer 11′ defines inside itself a center passage 30′ of the thermo roll 10′. In this example, the inner layer 11′ carries most of the thermo roll's 10′ own weight, of nip forces, and of the loads caused by other external forces. This cylindrical inner layer 11′ is of a strong, tough material that withstands bending well, but it need not necessarily be good in respect of its thermal conductivity, on the contrary, among other things, when heating and/or cooling merely through the flow passages provided in the shell of the thermo roll, thermal insulation capacity may be an advantage to limit heat appropriately for the treatment process of the fibrous web and to prevent heat transfer to bearing arrangements (not shown) of the thermo roll and therethrough to the frame structures of the machine.

FIG. 11 shows an inner layer 11′ of the thermo roll 10′, the outer surface 11a′ of which inner layer is provided with recesses or grooves 12′ which are at positions designed to be advantageous for flow passages and which, as being in the harder material 11′, can serve as forms that guide drilling when flow passages 15′ are formed later. The grooves 12′ are placed and dimensioned in an optimal manner, in particular to assure an even transfer and distribution of heat. The grooves 12′ are made in the inner layer 11′ forming the base of the thermo roll, for example, by machining, for example, by milling or drilling, or by forging or pressing, such as hot pressing, or by etching. It may be emphasized that in the layer on the inner side of the surface layer/in the heat transfer layer and in the inner layer of the shell of the thermo roll 10′ shown in FIGS. 11-13 there can also be flow passages (not shown), for example, a flow passage can be in its entirety in the inner layer 11′ surrounded by the heat transfer layer 13′, so that the flow passage is formed, for example, by a bore made into the inner layer 11′, or the flow passage can also be equally well in its entirety in the heat transfer layer 13′ surrounding the inner layer 11′.

FIG. 12 is a partial cross-sectional view of a semi-finished product of the thermo roll, in which a material layer is arranged around the grooved inner layer 11′ of the shell 10′ shown in FIG. 11, which material layer forms the heat transfer layer 13′ having an outer surface 13a′. The inner surface 13b′ of the material/the material layer 13′ forming the heat transfer layer 13′ or the main part of the heat transfer layer 13′ and having in this exemplifying embodiment the best thermal conductivity of the thermo roll 10′ conforms to the shapes of the outer surface 11a′ and to the grooves 12′ of the inner layer 11′ in FIG. 12. An enlarged detail of the area BB in FIG. 12 is shown on the right side of FIG. 12, in which in the groove 12′ placed in the outer surface of the inner layer 11′ there is material that is advantageously softer than the material of the inner layer 11′, such as the material of the heat transfer layer 13′. The grooves 12′ of the semi-finished product are opened, for example, by drilling, using the groove 12′ of the harder material as a guide groove. The finished bore of the roll construction is thus, for example, like the partial section AA showing a detail that has been drilled open on the left side of FIG. 12.

Alternatively, the heat transfer layer 13′ can be, for example, as shown in FIG. 14B, cylindrical in shape, in which case it would not extend to the area of the grooves 12′ in one possible intermediate stage of manufacture shown in FIG. 12. Generally, in the inner surface 14b′ of the surface layer 14′ and/or in the inner surface of some layer on the inner side of the surface layer 14′ there can be recesses or grooves 12′, whose cross-sectional profile shape constitutes a portion of the cross-sectional profile of the flow passage 15′, so that the recess or the groove 12′ forms the flow passage 15′ together with the outer surface of the inner material layer. In the outer surface of some material layer situated on the inner side of the surface layer 14′ there can also be recesses or grooves 12′, whose cross-sectional profile shape constitutes a portion of the cross-sectional profile of the flow passage 15′, so that the recess or the groove 12′ forms the flow passage 15′ together with the inner surface of the outer material layer. More generally, the inner surface and/or the outer surface of the material layer of the thermo roll shell can be provided with recesses or grooves 12′ to form flow passages 15′ or to receive flow tubes 16′.

FIG. 13 is a partial cross-sectional view of the shell of the thermo roll 10′ in accordance with a first embodiment of the invention, which shell is optimized in respect of its heat transfer properties and provided with flow passages 15′. The layer on the inner side of the surface layer/the heat transfer layer 13′ is surrounded by a wear-resistant surface layer 14′, the layer thickness of which is appropriately thinner than that of the layer on the inner side of the surface layer/the heat transfer layer, and the properties and the surface quality of the outer surface 14a′ of which meet the wear, process and other requirements set by use. The flow passages 15′ situated in the shell of the thermo roll 10′ for a flowing heat transfer medium, which flow passages are in this case heat transfer bores 15′ that are mainly parallel or almost parallel to the axis of the thermo roll 10′, are formed in the area of the grooves 12′ situated on the surface of the inner layer 11′ and illustrated in FIG. 11, which grooves 12′ are filled, as shown in FIG. 12, temporarily for the time of manufacture with a soft material, which is easy to drill open in the axial direction in a semi-finished product or in a full-size thermo roll. In this embodiment of the invention, the grooves 12′ serve as forms which are placed in the harder material 11′ and which guide drilling when the flow passages 15′ are drilled open. Generally, the flow passage 15′ can open in the boundary zone of two material layers into the inner surface or the outer surface of the material layer, i.e. here the flow passage 15′ opens in the boundary zone of the heat transfer layer 13′ and the inner layer 111′ to the outer surface 11a′ of the inner layer 11′ and to the inner surface 13b′ of the heat transfer layer 13′. The function of the heat transfer layer 13′ is to efficiently transfer the heat capacity introduced into the thermo roll 10 to the outer surface 14a′ of the surface layer 14′ of the thermo roll. The material having the best thermal conductivity is placed mainly between the system of flow passages 15′ designed to be placed at the grooves 12′ and the surface 14a′, in an area as large as possible in the heat transfer layer 13′. By this means, efficiency is achieved in heat transfer, whereby the temperature between the flowing medium, advantageously oil, and the surface 14a′ becomes small.

FIG. 13 shows that the thermo roll has a surface layer 14′ on the layer situated on the inner side of the surface layer/on the heat transfer layer 13′, by means of which layer the thermo roll becomes a three-layer thermo roll. It shall be emphasized that the existence of the surface layer 14′ is only optional and that the existence of the surface layer is substantially more important from the viewpoint of the wear resistance of the thermo roll and its surface structure withstanding compression and deflection loads. An advantageous surface layer is formed, for example, of a steel layer whose thickness can advantageously be 1-5 mm. The surface layer can also be a thin hardcoating of 0.01-2 mm.

FIG. 14B illustrates ways of forming the flow passage 15′ between two layers of the shell of the thermo roll 10′, which layers are placed one upon the other and which layers function as mating parts, in the area of the boundary surface of the mating parts. The grooves 12i and 12o can be provided beforehand on the boundary surfaces of the mating parts, i.e. the layers of the shell, such that when the mating parts are assembled, the grooves form a flow passage 15′. The flow passage 15′ can thus be formed only of the groove 12i provided in the inner part or only of the groove 12o provided in the outer part or of grooves provided both in the inner and in the outer part. The grooves 12i, 12o situated both in the inner and in the outer part and forming the flow passage 15′ can be advantageously placed exactly in opposed relationship or the grooves 12i, 12o can be laterally partly displaced with respect to each other.

FIG. 14A illustrates a thermo roll 20′ assembled of at least two parts in accordance with a second advantageous embodiment of the invention. Here, the shell of the thermo roll 20′, in particular the material layer that forms a heat transfer layer 23′ of the thermo roll shell or the main part of said heat transfer layer, is formed of parts 231′, 232′, 233′, etc. placed/assembled one after the other, and a surface layer 24′ of the thermo roll is formed of at least one part, said part being disc-shaped, annular or cylindrical. The part forming the surface layer and/or the part forming the heat transfer layer can thus be a continuous cylinder extending over the entire length of the thermo roll 20′ and being coaxial therewith. The surface layer 24′ of the thermo roll 20′ can also be composed of at least two surface layers of cylindrical parts (i.e. surface layers of sectional rolls which are shorter with respect to the length of the thermo roll) placed/assembled one inside the other and/or one after the other in the axial direction, which cylindrical parts are formed of parts that are continuous in the circumferential direction.

In the thermo roll in accordance with one embodiment of the invention, at least one part, such as the shell and/or the end part, has a non-homogeneous thermal conductivity or thermal expansion coefficient, i.e. thermal conductivity or thermal expansion coefficient changing with respect to location. Thus, the thermal conductivity of the shell in particular changes in the radial direction and/or the thermal conductivity of the end part in particular changes as a function of the axial direction. Said property can be provided by powder metallurgical means.

The part forming the layer on the inner side of the surface layer/the heat transfer layer 23′ is disposed or the parts forming the heat transfer layer 23′ are assembled in the axial direction around an inner part, i.e. an inner layer 21′ which functions as the base of the thermo roll 20′ and is formed of one or more continuous tubular parts. For the sake of clarity, FIG. 14A does not show the surface layer 24′ of the thermo roll 20′ assembled around the heat transfer layer 23′. The surface layer 24′ can be formed of one or more parts or it can be made, instead of a continuous part/an assembly of continuous parts, into a continuous material layer arranged around the material layer on the inner side of it, for example, by casting, welding, thermal spraying, layering, pressing or by another equivalent manufacturing method forming a continuous layer. It shall also be noted that the thermo roll 20′ in accordance with the invention can also be without the surface layer 24′ and/or without the inner layer 21′.

In a second embodiment of the invention, flow passages 25′ or flow openings 25′ can be provided in the separate parts 231′, 232′, 233′, etc. already before the assembly of the thermo roll 20′, as shown in the middle part of FIG. 14A, such that, when the parts 21′, 231′, 232′, 233′, etc. have been joined together, the flow passages 25′ are connected and form a system of flow passages 25′ going through in the assembled thermo roll. The separate parts 21′, 231′, 232′, 233′, etc. and 24′ can be advantageously provided already before the assembly of the thermo roll 20′ with the possibly needed forms (not shown) required by the fixing and/or joint members such that, when the shell parts have been joined together, the fixing and/or joint forms, for example, the holes of fixing bolts or joint forms with interlocking shapes, fit one another. The mating surfaces of the parts are machined before assembly or they are already sufficiently smooth so that the assembled thermo roll 20′ is tight.

The parts forming each material layer 21′, 23′ and 24′ in FIG. 14A are formed in respect of inside and outside measurements and surface quality such that they can be assembled appropriately in connection with each particular attachment technique. Thus, the joint between the outer surface 21a′ of the inner layer and the inner surface 23b′ of the layer on the inner side of the surface layer/the heat transfer layer as well as the joint between the outer surface 23a′ of the heat transfer layer and the inner surface 24b′ of the surface layer each have such mechanical fit values and the above-mentioned surfaces each have such surface quality values as are determined according to the material properties of each part to be attached and according to the desired method of attachment.

In the thermo roll 20′ in accordance with a variant of the second embodiment of the invention (not shown by a figure), the flow passages arranged in the shell of the thermo roll are arranged in connection with the layer situated on the inner side of the surface layer/the heat transfer layer 23′ in the boundary zone of the heat transfer layer 23′ and the inner layer 21′. In that case, the flow passages are formed by flow passage recesses or grooves which are formed in the outer surface 21a′ of the tubular inner part 21′ and which are inner recesses or grooves in the radial direction of the thermo roll and by curved peripheral portions provided in the cylindrical inner surface 23b′ of the part/parts forming the heat transfer layer 23′ and located in opposed relationship to each recess or groove. The inner surfaces 23b′ may also comprise outer recesses or grooves in the radial direction of the thermo roll, which recesses or grooves form the outer part of the flow passages. When the inner part 21′ and the part/parts forming the heat transfer layer 23′ have been assembled, the inner and outer parts of the flow passages form together a system of through-going flow passages.

FIG. 15 shows the shell of a thermo roll 101′ in accordance with a third embodiment of the invention. The shell of the thermo roll 101′ of FIG. 15 comprises two material layers whose thermal conductivity changes in a layer by layer fashion in the radial direction of the thermo roll 101′. A material layer that conducts heat better is arranged to form one heat transfer means of the thermo roll 101′, said material layer forming a heat transfer layer 13′, which in FIG. 15 is on the inner side of a thermally less conductive surface layer 14′.

The thermo roll 101′ shown in FIG. 15 can be heatable from inside, so that the inner surface 13b′ of the inner heat transfer layer 13′ defines within itself a center passage 30′ as a second heat transfer means of the thermo roll 101′, a heat transfer medium flowing in said center passage, or the center passage 30′ is provided with a third heat transfer means, such as an internal induction heating coil in a Tokuden roll, or the thermo roll 101′ can also be provided with flow passages (not shown) arranged in the shell by means of fourth heat transfer means, among other things, to reduce thermal stresses during heating and cooling of the shell of the thermo roll 101′. One big problem with internally heatable rolls has been the relatively high heat transfer resistance caused by a thick shell, for example, when the shell material has had low thermal conductivity and/or the heat transfer distance to the outer surface has been large, wherefore the temperature difference between the inner parts and the outer surface of the thermo roll has been great, readily of the order of 100° C. If the material layer that forms a heat transfer area, i.e. an area across which the heat capacity to be transferred to the fibrous web is transferred to the shell of the thermo roll and across which the heat capacity to be transferred from the fibrous web is transferred from the shell of the thermo roll, for example, a layer between the flow passages arranged in the shell of the thermo roll 101′ and its outer surface, in the case of FIG. 15 the layer between the center passage 30′ and the outer surface 14a′, mainly the heat transfer layer 13′, is mostly, for example, of copper or another equivalent material that conducts heat particularly well, heat transfer can be enhanced considerably. In practice, the temperature difference effective across the shell is reduced to a fraction with the same total capacity, for example, from 100° C. to about 20-25° C.

In FIG. 15, the heat transfer layer 13′ constituting the main part of the shell of the thermo roll 101′ can be of a material that conducts heat particularly well, for example, of a copper alloy. In addition to this, as the surface layer 14′ it is possible to use a material layer, such as a steel layer, that provides strength against compression and deflection loads. In the case of FIG. 15, a particularly good arrangement is to place the heat transfer layer 13′ in the inner parts of the thermo roll 101′ and the thinner steel shell 14′ outside it, although a different arrangement is also feasible. As suitably alloyed, the material used for the heat transfer layer 13′, such as copper or an equivalent material conducting heat better than steel, can be sufficiently strong to form the base or the load-bearing layer of the thermo roll, even so that only a thin hardcoating is needed to form the surface layer 14′, i.e. for the outer surface 14a′ of the thermo roll 101′. The innermost layer of the thermo roll 101′ serving as the heat transfer layer 13′ can be the layer mainly carrying the load caused by the thermo roll's own weight, nip forces and other external forces or the layer 13′ conducting heat better than the surface layer 14′ can be arranged to form the load-bearing layer.

FIG. 16 shows the shell of the thermo roll 101′ in accordance with a variant of the third embodiment of the invention. The shell of the thermo roll 101′ in FIG. 16 comprises two material layers whose thermal conductivity changes in a layer by layer fashion in the radial direction of the thermo roll 101′. A material layer that conducts heat better is arranged to form one heat transfer means of the thermo roll 101′, said material layer forming a heat transfer layer 13′ which in FIG. 16 is outside the thermally less conductive innermost layer 11′. The material of the innermost layer 11′ is selected optimally with respect to internal induction heating such that eddy currents are induced well in the material. Outside the heat transfer layer 13′ there can also be a thin, thermally less conductive surface layer 14′, said surface layer being shown with broken lines in FIG. 16. The thermo roll 101′ shown in FIG. 16 can be heatable from inside, so that the inner surface 11b′ of the innermost layer 11′ defines within itself a center passage 30′ as a second heat transfer means of the thermo roll 101′, a heat transfer medium flowing in said center passage, or the central passage 30′ is provided with a third heat transfer means, such as an internal induction heating coil in a Tokuden roll, or the thermo roll 101′ can also be provided with flow passages (not shown) arranged in the shell by means of fourth heat transfer means, among other things, to reduce thermal stresses during heating and cooling of the shell of the thermo roll 101′.

In FIG. 18, the heat transfer layer 13′ constituting the main part of the shell of the thermo roll 101′ can be of a material that conducts heat particularly well, for example, of a copper alloy. In addition to this, as the possible surface layer 14′, it is possible to use a material layer, such as a steel layer, that provides strength against compression and deflection loads. In the case of FIG. 16, a particularly good arrangement is to arrange the thick heat transfer layer 13′ to form the surface layer of the thermo roll 101′ outside the innermost layer 11′ whose material is, for example, iron, steel, aluminum or another similar material well heatable by induction. As suitably alloyed, the material used for the heat transfer layer 13′, such as copper or an equivalent material conducting heat better than steel, can be sufficiently strong to form the base or the load-bearing layer of the thermo roll, even so that only a thin hardcoating is possibly needed to form the surface layer 14′, i.e. for the outer surface 14a′ of the thermo roll 101′. The heat transfer layer 13′ can be the layer mainly carrying the load caused by the thermo roll's own weight, nip forces and other external forces or the innermost layer 11′ optimal with respect to induction heating can be the load-bearing layer.

By placing a steel shell outermost, i.e. to form the surface layer 14′, more deflection and compression stiffness is imparted to the thermo roll, because the strong steel layer is situated farther from the neutral axis of deflection. Thus, the surface layer 14′ of the thermo roll 101′ can also serve as the layer mainly carrying the load caused by the thermo roll's own weight, nip forces and other external forces or the layer 14′ that is thermally less conductive than the inner heat transfer layer 13′ can be arranged to form mainly the load-bearing layer.

In FIG. 16, from the thermal viewpoint, the placement of the steel shell 14′ outermost is advantageous in the sense that, as a poorer heat conductor, the steel layer 14′ sort of slows down heat transfer in the vicinity of the outer surface 14a′, so that temperature differences have time to even out in the material layer that transfers heat better and forms the heat transfer layer 13′, such as a copper layer. The evening out of the temperature differences is particularly important in the Tokuden construction in which it is necessary to use special heat equalization chambers in the shell of the thermo roll because of the uneven heating effect of the heating elements arranged in sections, which heat equalization chambers are partly filled, for example, with a suitable filling agent, such as naphthalene.

The arrangement shown in FIGS. 15 and 16 makes it possible to combine the internal heating of the thermo roll 101′, such as Tokuden heating, and a layered thermo roll shell made of at least two material layers and/or flow passages shown in FIGS. 10-14B and placed in the shell of the thermo roll can be arranged in the thermo roll 101′ for cooling and/or for heating.

The advantages of the embodiments shown in FIGS. 15 and 16 include significantly better thermal conductivity in the shell of the thermo roll 101′, which leads to the following benefits: a higher total capacity is possible; a higher surface temperature is possible; a lower internal temperature is needed for the same surface temperature, which means that the heat introduction means and machine members arranged in the interior of the thermo roll 101′ last longer; and a higher specific heating capacity, so that a smaller roll diameter is possible.

When selecting the combination of materials of the different layers in FIGS. 10-16, strength and thermal expansions have been taken into account as limitations.

In FIGS. 10-14, the material used for the inner layer 11′, 21′ is, for example, carbon steel or cast iron, the benefits of which can be considered to be strength, inexpensive application and mechanical reliability. The inner layer 11′, 21′ can be, for example, a forged steel shell. The layer on the inner side of the surface layer/the heat transfer layer 13′, 23′ is formed, for example, of copper or advantageously of a copper alloy, such as, for example, CuCrZr. As the material of the layer on the inner side of the surface layer/the heat transfer layer 13′, 23′ it is also possible to use brass, tin, aluminum, zinc, chrome, zirconium, nickel, steel or the like. An alloy or a composition metal containing said metals can also be the material of the heat transfer layer.

The material used for the surface layer 14′, 24′ is, for example, low carbon steel. Alternatively, the surface is provided with a hard wear-resistant layer by means of a hardcoating, for example, a chrome coating or a ceramic coating or by thermally spraying or welding a hardlayer to the surface. Alternative other properties the surface layer is desired to have are strength, toughness, hardness, wear resistance, suitable thermal expansion, surface quality, cleanability or the like. If the surface layer 14′, 24′ is a poorer heat conductor than the heat transfer layer 13′, 23′, the surface layer is sought to be kept thinner than the heat transfer layer in order that the total thermal conductivity of the thermo roll shell shall not be reduced too much. The surface layer 14′, 24′ can be even very thin and, for instance, a chrome plated layer or another hardcoating or ceramic layer can be applied if the mechanical properties of the layer on the inner side of the surface layer/the heat transfer layer 13′, 23′ are sufficient to withstand the stresses arising through nip load and the thermal stresses of the thermo roll in order that the possibly hard and brittle surface layer shall remain fixed to the heat transfer layer 13′, 23′.

It is possible to transfer the high heating and cooling capacities required by the new calendering methods mentioned at the beginning, thus ensuring that sufficient heat capacity is transferred through the shell of the thermo roll 10′, 20′ to the nip and further to the fibrous web to be treated, and vice versa, also by reducing the heat transfer distance between the heat transfer area of the thermo roll 10′, 20′ and the outer surface 14a′, 24a′ of the surface layer 14′, 24′ of the shell.

In the thermo roll in accordance with one advantageous embodiment of the invention, a significant improvement in heat transfer is achieved by arranging a heat transfer area close to the surface layer of the thermo roll 10′, 20′, in which connection the heat transfer area of the thermo roll can be heated and/or cooled by means of flow passages 15′, 25′, 151′, 152′ arranged in the shell of the thermo roll 10′, 20′. It is then also possible to use less unconventional materials or conventional materials, such as ferrous metals, advantageously steel, for the heat transfer layer 13′, 23′ and/or for the surface layer 24′, 14′. In order that heat may be transferred close to the surface 14a′, 24a′, at least some of the flow passages 15′, 25′, 151′, 152′ are placed close to the surface 14a′, 24a′, as measured at their center line, advantageously at a distance of 50 mm at the most from the outer surface 14a′, 24a′ of the thermo roll, preferably at least some of the flow passages 15′, 25′, 151′, 152′ are placed, as measured at their center line, at a distance of 10-40 mm from the outer surface 14a′, 24a′ of the thermo roll. When the flow passages are placed so close to the surface 14a′, 24a′, the thermo roll 10′, 20′ can be, in a layer by layer fashion, entirely or partly of steel, cast iron or another suitable material.

When the heat transfer area is arranged close to the surface layer of the thermo roll 10′, 20′, 101′ the structure of the thermo roll can be such that the inner part of the thermo roll is formed of a continuous, advantageously tubular part, which forms the innermost material layer 11′, 21′ of the thermo roll or the heat transfer layer 13′, 23′ placed on the innermost material layer. To form flow passages 15′, grooves 12′, 12b′ are formed, for example, by milling or hot pressing in the outer surface 11a′, 21a′ of the innermost material layer 11′, 21′ and/or in the outer surface 13a′, 23a′ of the layer on the inner side of the surface layer/the heat transfer layer 13′, 23′, the cross-sectional profile shapes of which grooves constitute a portion of the cross-sectional profiles of the flow passages 15′, 25′ of the heat transfer medium. The flow passages 15′, 25′ can also be in their entirety in accordance with the invention passages that are formed, for example, by drilling into a material that conducts heat particularly well.

The flow passages 15′ are thus formed between the outer material layer, which can be the heat transfer layer 13′, 23′ or the surface layer 14′, 24′ of the thermo roll, and the inner material layer, which is correspondingly the material layer 11′, 21′ or the heat transfer layer 13′, 23′.

The surface layer 14′ of the base of the single- or multi-layer thermo roll can be formed, for instance, using the HIP, welding, soldering or thermal contraction method.

The surface layer 14′ of the shell of the single- or multilayer thermo roll or, generally, some layer of the shell of the thermo roll can be formed in a separate manufacturing stage using the HIP method, by welding, casting, forging or milling. The surface layer 14′ or, generally, some layer of the shell of the thermo roll can be fixed or assembled onto the layer situated on the inner side in a separate manufacturing stage using the HIP method, by welding, soldering or thermal contraction, using an interlocking joint or by means of bolts.

In order that the temperature distribution of the surface 14a′, 24a′ of the thermo roll 10′, 20′ might be made even, it is advantageous to form, for the purpose of providing flow passages 15′ for a heat transfer medium,
a large number of bores in the layer 13′, 23′ which is on the inner side of the surface layer 14′, 24′ and which is most advantageously of a metal material that conducts heat particularly well, and/or
a large number of grooves 12′ in the inner surface 13a′, 23a′ of the layer 13′, 23′ on the inner side of the surface layer 14′, 24′.

When the layers of the thermo roll 10′, 20′ are of the same material in a layer by layer fashion, an advantage arising from the arrangement described above is that problematic thermal stresses are not created in the shell of the thermo roll, especially not in the boundary zone of the material layers. In addition, the load-bearing capacity of the thermo roll 10′, 20′ is good when, for example, steel is used as the material of the material layers.

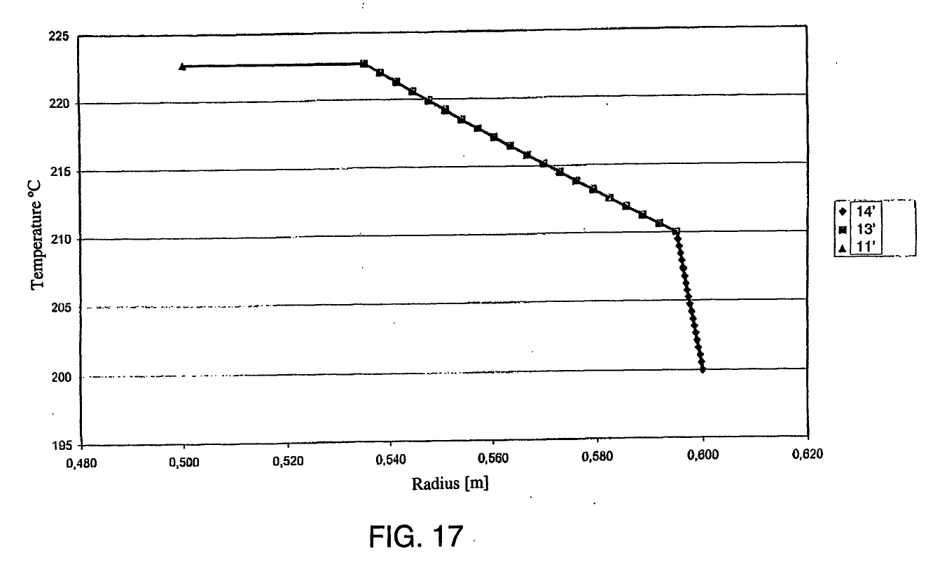

FIG. 17 shows an exemplifying diagram of the temperature distribution in the shell of the thermo roll in accordance with one first embodiment of the invention. The computational temperature distribution of the material layers, i.e. the inner layer 11′, the heat transfer layer 13′ and the surface layer 14′, of the thermo roll like the one shown in FIGS. 11-13 and optimized in respect of its heat transfer properties is shown by means of a graph of temperature [° C.] against radius [m]. The measurements of the different layers of the shell of this oil-heatable thermo roll are, expressed as layer thicknesses in the radial direction of the thermo roll, as follows: the thickness of the inner layer 11′ is 35 mm, the thickness of the heat transfer layer 13′ is 60 mm and the thickness of the surface layer 14′ is 5 mm, while the outside diameter is 1200 mm. When the radius of the inner layer 11′ of the example roll is between 0.500 m and 0.535 m, temperature is calculated to remain constant 222.5° C., which is also the temperature of heating oil. The flow passages are computationally at a radius of 0.535 m in the boundary zone of the inner layer 11′ and the heat transfer layer 13′. The temperature of the heat transfer layer 13′ in a radial range of 0.535 m to 0.595 m decreases almost linearly from the value of 222.5° C. to the value of 210° C. The temperature of the steel surface layer 14′ in a radial range of 0.595 m to 0.600 m decreases linearly sharply from the temperature value of 210° C. to the value of 200° C., the total temperature difference between the heating oil and the surface 14a′ being thus 22.5° C. in the example of the diagram.

In the thermo roll 10′, 20′, 101′ in accordance with one embodiment of the invention as well as in a semi-finished product for the thermo roll 10′, 20′, 101′ in accordance with one embodiment of the invention, the inner surface 13b′, 14b′, 23b′, 24b′ and/or the outer surface 11a′, 13a′, 21a′, 23a′ of the material layer is/are provided with recesses or grooves 12′, whose cross-sectional profile shapes constitute a portion of the cross-sectional profile of the flow passages 15′, 25′, so that the recesses or grooves 12′ form flow passages 15′, 25′ together with the inner surface of the outer material layer or with the outer surface of the inner material layer to form the flow passages 15′, 25′ or to receive flow tubes 16′.

In the method of manufacturing a thermo roll in accordance with the invention, material layers are arranged one inside the other in the shell of the thermo roll 10′, 20′, 101′ to enhance the heat transfer properties of the thermo roll 10′, 20′, 101′. In the embodiments of the invention shown in FIGS. 10-14A, a material layer having higher thermal conductivity than the thermal conductivity of the inner layer 11′, 21′ can be arranged between the inner layer 11′, 21′ and the surface layer 14′, 24′ of the thermo roll 10′, 20′ to form the heat transfer layer 13′, 23′, and a material layer having higher thermal conductivity than the thermal conductivity of the surface layer 14′ can be arranged to form the heat transfer layer 13′ as the innermost material layer of the thermo roll 101′ shown in FIGS. 15 and 16.

In the methods for manufacturing the thermo roll 10′, 20′, 101′ intended for the treatment of a fibrous web, the shell of which thermo roll comprises at least two material layers, which thermo roll or the shell of which thermo roll is provided with heat transfer means for heating and/or cooling the shell of the thermo roll, advantageously by means of a heat transfer medium, in accordance with the first method of the invention, at least two material layers 11′, 13′, 14′, 21′, 23′, 24′ are arranged radially one within the other in the shell of the thermo roll, which material layers are different in their manufacturing technique and which material layers are manufactured with respect to their manufacturing technique in different stages or by different methods, and heat transfer medium flow passages 15′, 25′, 151′, 152′ are arranged to be confined by at least one of said material layers inside itself or situated in a boundary zone of said material layers, and in accordance with the second method of the invention, different material layers 11′, 13′, 14′, 21′, 23′, 24′ are arranged in layers radially one within the other in the shell of the thermo roll, the thermal conductivities of at least two of which material layers are different from one another, and that heat transfer medium flow passages 15′, 25′, 30′, 151′, 152′ are arranged in at least one of said material layers or to be confined by at least one of said material layers inside itself or to be situated in a boundary zone of said material layers.

A significant improvement of heat transfer can be achieved by arranging a heat transfer area close to the surface layer of the thermo roll 10′, 20′.

Some advantageous exemplifying embodiments of the method of manufacturing the thermo roll 10′, 20′ are described in the following. At least one material layer, in particular the heat transfer layer 13′, of the material layers of the thermo roll shell of the thermo roll 10′ in accordance with a first embodiment of the invention and of the thermo roll comprising a system of flow passages 151′ formed of tubes 16′ in accordance with a variant of the first embodiment can be manufactured, in accordance with the invention, by pressing, advantageously by hot isostatic pressing, i.e. the HIP process, and by cutting associated therewith, when needed, and by the associated assembly, when needed. The material layers of the thermo roll 10′ in accordance with the first embodiment of the invention can also be manufactured by other methods known in themselves, for instance, the heat transfer layer 13′ can be manufactured by casting it around the inner layer 11′.

The material layers, in particular the heat transfer layer 23′, of the shell of the thermo roll 20′ assembled of parts in accordance with a second embodiment of the invention and of the thermo roll in accordance with a variant of the second embodiment can be advantageously manufactured, in accordance with the invention, by hot pressing and by milling associated therewith, when needed, and by the associated assembly, when needed. The material layers of the thermo roll 20′ in accordance with the second embodiment of the invention and, similarly, of the thermo roll in accordance with the variant of the second embodiment can also be manufactured by methods known in themselves by milling, casting or the like and, when needed, by the associated assembly.

The manufacture of the shell of the thermo roll in accordance with the first embodiment of the invention by means of hot pressing is described in the following. Tubular blank moulds dimensioned as desired for use in hot pressing are manufactured first and the HIP manufacturing technique is then used. The material used for the heat transfer layer 13′ as the starting material of hot pressing is a fine metal powder, for example, CuCrZr, which is converted into a solid metal part in the process. The metal powder is placed in the HIP mould, compacted by vibrating, encapsulated gas-tightly and pressed at high temperature and at high pressure for a certain time of action. The temperature, the pressure and the time of action of the hot pressing process are controlled to optimize the properties of the material that is hot pressed. In this case, typical hot pressing process parameters are represented by the following exemplifying values: temperature 900±10° C., pressure 105±5 MPa and time of action 2-3 h. If the inner layer 11′ of the thermo roll is included in the hot pressing process, for example, placed radially on the inner side of the material which is initially in powder form and forms the heat transfer layer 13′, it receives advantageous stress relief annealing due to the effect of temperature. In the process, the waste of material is minimized and the part to be manufactured has a good surface quality and dimensional accuracy. Moreover, it becomes possible to manufacture complex shapes and to arrange optimally placed flow passages 15′ within the heat transfer layer.

In the hot pressing process, the drilling passages or grooves 12′ can be filled temporarily for the time of manufacture with a soft material, such as copper, which is easy to drill open in a semi-finished product or in a full-size thermo roll.

After completion of the hot pressing process and after cooling of the shell or a part of the shell of the thermo roll, it is machined, when needed, to produce the designed forms and the desired surface quality.

Thus, into the thermo roll 10′ in accordance with the first embodiment of the invention, in particular into the heat transfer layer 13′ of the thermo roll shell it is possible to drill flow passages 15′, i.e. heat transfer bores 15′, formed for a flowing heat transfer medium as shown in FIG. 13 by using the recesses or grooves 12′ in the surface of the base layer 11′ as forms that guide drilling. In addition, when needed, the measurements and the surface quality of the part formed by hot pressing are arranged to be as desired for the subsequent attachment of the surface layer 14′, for example, by grinding. The surface layer 14′ made, for example, of a solid material is attached to the thermo roll 10′ around the heat transfer layer 13′, for example, by thermal contraction, i.e. by joining with a shrink fit/an interference fit, by soldering, welding, for example, by friction stud welding, or the like. Other applicable alternative coatings are described above in connection with the surface layer 14′. The grinding of the surface 14a′ of the thermo roll 10′ to the desired surface quality is performed before the first time of process use, for example, after the final assembly of the thermo roll 10′.

In the thermo roll in accordance with a variant of the first embodiment of the invention, the flow passages 151′ in the heat transfer layer 13′ of the shell are formed, for example, as follows. The metal powder that is to form the heat transfer layer 13′ in hot pressing and the flow tubes 16 that are to form the flow passages 151′ are placed in a HIP mould. The metal powder is compacted by vibrating, encapsulated gas-tightly and pressed at high temperature and at high pressure for a certain time of action, as in the case of the thermo roll in accordance with the first embodiment. The flow tubes 16′ arranged in the heat transfer layer 13′ receive advantageous stress relief annealing in the hot pressing process due to the effect of temperature. In the hot pressing process, the waste of material is minimized and the part manufactured has a good surface quality and dimensional accuracy.

In the thermo roll manufactured by hot pressing in accordance with a variant of the first embodiment of the invention, within the metal powder that forms the heat transfer layer 13′, a system of flow passages 151′, which is shown in FIG. 10 and placed in an optimal manner, can be formed out of tubes 16′ of steel or copper, as mentioned above. In that connection, different variants of flow passages, even ones previously impossible to manufacture, such as, for example, passages 151′ which deviate from the axial direction of the thermo roll 10′, which passages are spiral and at different distances in the radial direction from the center line of the thermo roll 10′, can be accomplished by placing the flow tube 16′ in the hot pressing process within the metal powder forming the heat transfer layer 13′ between the thermo roll base 11′ forming the inner layer of the thermo roll 10′ and the surface layer 14′ forming the outer surface. To optimize the distribution of heat, the flow tube 16′ can be dimensioned to be optimal in respect of its flow rate for each location where it is placed.

In the thermo roll assembled out of parts in accordance with another variant of the second embodiment of the invention, a system of flow passages 151′ can also be formed, in the manner mentioned above, out of tubes 16′ made, for example, of steel or copper. In that connection, different variants of flow passages, even ones previously impossible to manufacture, such as, for example, passages 151′ which deviate from the axial direction of the thermo roll 20′, which passages are spiral and at different distances in the radial direction from the center line of the thermo roll 20′, can be accomplished by placing the flow tube 16′ in connection with the hot pressing process within the part/parts forming the heat transfer layer 23′. To optimize the distribution of heat, the flow tube 16′ can be dimensioned to be optimal in respect of its flow rate for each location where it is placed.

The manufacture of the thermo roll 20′ in accordance with the second embodiment of the invention is illustrated by means of FIG. 14A. The thermo roll 20′ is assembled out of separate solid parts. The parts 231′, 232′, 233′, etc. forming the material layers of the shell of the thermo roll 20′, in particular the parts forming the heat transfer layer 23′ and the surface layer 24′ of the thermo roll, can be disc-shaped or annular or in particular cylindrical, as in FIG. 14A. They can be continuous co-axial cylinders placed radially one within the other and extending over the entire length of the thermo roll 20′ or they can be continuous in the circumferential direction, but assembled, in the axial direction of the thermo roll, out of at least two shorter parts or they are manufactured out of at least one part. The parts of the heat transfer layer 23′ or of the surface layer 24′ can be assembled together in the axial direction around a roll shaft 21′ that serves as the innermost material layer and as the base of the thermo roll or around a preferably tubular roll shaft 21′ that is continuous/assembled of separate parts. To assure the stiffness of the thermo roll 20′ it may be necessary that only the heat transfer layer 23′ of the shell and, when needed, the surface layer 24′ are assembled in the manner described above, and the inner layer 21′ is a continuous, fairly stiff tubular part 21′, for example, a forged steel shell. For the sake of clarity, FIG. 14A does not show the surface layer 24′ of the thermo roll 20′ as assembled around the heat transfer layer 23′.

The parts 231′, 232′, 233′, etc. shown in FIG. 14A, which parts can be assembled and which form the heat transfer layer 23′, can be manufactured, for example, by forging, casting or by using thin rolled sheets available as ready-made sheets or by hot pressing. The manufacture of the separate parts 231′, 232′, 233′, etc. forming the heat transfer layer 23′ in accordance with the second embodiment shown in FIG. 14A is not particularly described in this connection, but reference is made to the description of the hot pressing process in connection with the first embodiment of the invention. The flow opening to be left in the parts can be machined or it is obtained as finished in the casting or hot pressing process. The flow opening can be die cut into thin parts.

In the second embodiment of the invention shown in FIG. 14A, the flow passages 25′ or the flow openings 25′ are made beforehand in the separate parts 231′, 232′, 233′, etc. before the assembly of the thermo roll 20′ such that, when the parts are fixed to one another, the passages 25′ join and form a through-going system of passages 25′ in the assembled thermo roll. When the flow passages 25′ of the heat transfer medium can be placed in the shell structure already in the manufacturing stage, without needing to drill them into a full-size thermo roll, overlong drillings which are difficult during manufacture are avoided.

The separate parts 231′, 232′, 233′, etc. of FIG. 14A are provided already before the assembly of the thermo roll 20′ with the possibly needed forms (not shown) required by the fixing and/or joint members such that, when the shell parts are joined together, the fixing and/or joint forms, for example, the holes of fixing bolts or joint forms with interlocking shapes, fit one another. The mating surfaces of the parts 231′, 232′, 233′, etc. are machined before assembly or they are already sufficiently smooth, for example, after hot pressing so that the assembled thermo roll 20′ will be tight. The different layers to be assembled on the continuous inner layer 21′ of FIG. 14A can be attached to one another by welding, thermal contraction, soldering, or in a similar manner, or by using bolts, for example, through the entire thermo roll 20′. In the latter case, the manufacture of the thermo roll 20′ resembles the manufacture of the traditional filled roll, in which the shell of the roll is assembled by stacking and pressing sheets made of fibers around a shaft. It is also possible to use an adhesive on the joint surfaces to strengthen the joint. In addition, it may be necessary to seal the joints to eliminate any leakages of the flow medium.

In the second embodiment of the invention, the material properties of each part assembled radially one within the other and/or axially one after the other, i.e. the material properties of the inner layer 21′, the parts 231′, 232′, 233′, etc. assembled one after the other and forming the heat transfer layer 23′, and the surface layer 24′, are dimensioned taking into account the final roll position of the part.

In the first embodiment of the invention, the material properties of each different material layer, i.e. the inner layer 11′, the heat transfer layer 13′ and the surface layer 14′, are dimensioned taking into account the roll position of the layer.

At the web area in particular, the material layers of the layer on the inner side of the surface layer or the heat transfer layer 13′, 23′ and/or the surface layer 14′, 24′ can be arranged to be of materials that are thermally more conductive than the materials outside the web area. A material that is thermally less conductive is selected for the area outside the web, so that the thermo roll is thermally less conductive outside the web area than in the web area. In other words, the material layer of the thermo roll shell forming the heat transfer layer, is can be arranged to extend in the axial direction of the thermo roll substantially only across the width of the web area of the fibrous web such that substantially outside the web area the shell of the thermo roll is formed of a material that is thermally less conductive than the heat transfer layer.

The flow passages 15′, 25′, 151′, 152′ and the flow tubes 16′ are dimensioned taking into account the position of the flow passage in the shell of the thermo roll. Thus, the flow in the flow passages 15′, 25′, 151′, 152′ and in the flow tubes 16′ can be limited to assure the evenness of heat transfer, for example, by throttling the heat transfer bores 15′, 152′, for example, over at least part of their length by means of tubes 16′, so that the cross-sectional area of the flow passage 15′ is reduced and the flow velocity increases or the flow can be retarded by enlarging the size of the flow passages or tubes or the direction of the flow in adjacent flow passages 15′ can be arranged in different directions.

Thus, in accordance with a variant of the first embodiment of the invention, the flow diameter of the flow tubes 16′ forming the system of flow passages 15′ can increase or decrease depending on the location of the flow passage 15′ in the radial direction of the thermo roll and depending on the location of the flow passage 15′ in the axial direction of the thermo roll such that the evenness of heat transfer is assured on the outer surface 14a′ of the thermo roll 10′.

To achieve a corresponding effect, the flow openings 25′ of the parts 231′, 232′, 233′, etc., which form the heat transfer layer 23′ and are assembled one after the other as shown in FIG. 14A of the second embodiment of the invention, can become smaller or larger in the axial direction of the thermo roll 20′ such that the end result is flow passages 25′ variable in diameter, which enables the evenness of heat transfer on the outer surface of the thermo roll 20′. In the separate parts 231′, 232′, 233′, etc. it is possible to construct a sufficient number of flow passages 25′, possibly in the radial direction at different distances from the center line of the thermo roll 20′. The heating and the cooling of the thermo roll can then be controlled according to the operating situation, for example, by guiding the flow through as many passages as possible in the heating and cooling stage, so that capacity is distributed into as large an area as possible.

In the normal operating situation, the flow can be guided only to some of the flow passages 15′, 25′, 151′, 152′, for example, to the passages situated closest to the outer surface of the thermo roll. The flow passage functions of the so-called end part (not shown in the figures), which are feed passages, leading to the flow passages of the shell, and their joining or branch connections, can be placed, for example, in an annular part assembled in the ends of the thermo roll. When desired, no actual end part is thus needed in the thermo roll 20′, but corresponding flow ducts are constructed in the outermost annular part of the shell of the thermo roll comprising a heat transfer layer situated mainly in the web area. It is also possible to connect passages, when needed, closer to the middle of the thermo roll, farther away from the ends of the thermo roll, if it is considered necessary.

The connection and introduction of the flow passages 15′, 25′, 151′, 152′ to the heat transfer layer 13′, 23′ can be selected in different ways. The passages can be passed even in the inner part of the thermo roll to the edge of the web area, from which they are passed in the radial direction through the inner layer 11′, 21′ of the shell up to the heat transfer layer 13′, 23′. Here the flow passages 15′, 25′, 151′, 152′ can turn into the longitudinal direction of the thermo roll 10′, 20′, 101′. A separate end part is not necessarily needed for heat transfer, so that the loss of heat in the end areas is reduced. The end part needed for the thermo roll 10′, 20′, 101′ for some other reason can be insulated with respect to the heat transfer layer situated in the web area or the material of the end part can be selected such that the heat transfer in it in the axial direction and losses through the end surface are small. The material of said end part can also be fibrous, orthotropic or insulating.

The flow passages 15′, 25′, 151′, 152′ and the possible recesses or grooves 12′ of the thermo roll are advantageously optimized in respect of their cross-sectional profile, size and cross-sectional area so as to be exactly the kind of passages or parts of passages in which heat transfer between the medium and the outer surface of the thermo roll shell is as efficient and as even as possible. The location of the flow passages 15′, 25′, 151′, 152′ in the radial direction, i.e. in the depth direction, of the thermo roll is optimized taking into account the evenness requirements of heat. The cross-sectional profile of the flow passages 15′, 25′, 151′, 152′ and the grooves 12′ of the thermo roll can also be different from the conventional circular shape, for example, oval, angular or star-shaped.

In accordance with one embodiment of the invention, the heat transfer layer and the surface layer are made of a solid material into a part, for example, by hot pressing or by casting, before the assembly of the thermo roll or before the parts of the thermo roll are attached to one another. The layers of the finished thermo roll shell then comprise mainly two materials.

In accordance with one advantageous embodiment, the surface layer, which is mainly of the same material, is layered in a different manufacturing stage by hot pressing, i.e. using hot isostatic pressing, on the inner layer of the thermo roll shell, which is a forged tubular steel shell, the starting material of the surface layer to be hot pressed being in powder form. By means of layers that are mainly of the same material it is possible to advantageously achieve a situation in which the different layers of the thermo roll shell have almost identical thermal expansion. In this way, the thermal stresses arising from variations in the temperatures of the thermo roll shell are advantageously minimized. Of course, the above-mentioned, for example, thin and hard coating can additionally serve as a surface layer that is in contact with the fibrous web or the wire.

In accordance with one embodiment of the invention, the inner layer and the surface layer are made of the same material, so that the layers of the shell of the finished thermo roll comprise mainly two materials.

In the method that employs the thermo roll of high heat transfer in accordance with the invention, the fibrous web is brought into contact with the surface 14a′, 24a′ of the thermo roll 10′, 20′, 101′. In the method, when the thermo roll is heated, heat is transferred to the fibrous web across the heat transfer means of the thermo roll, such as the heat transfer layer 13′, 23′ and/or the flow passages 15′, 25′, 151′, 152′, and/or the outer surface 14a′, 24a′ of the thermo roll 10′, 20′, 101′ serves as a support surface against which the fibrous web to be treated can be wet pressed, dried, calendered, glazed and/or compacted and/or, when the thermo roll is cooled, heat is transferred out of the thermo roll and its shell across the heat transfer means.

The thermo roll 10′, 20′, 101′ of the invention intended for the treatment of a fibrous web can be heated or cooled using heat transfer means provided inside or outside the shell, advantageously internally, by means of a heat transfer medium. In addition, it is possible to use heating based on induction and/or friction and/or resistive heating and/or heating based on condensation and/or hot air blowing.

In the first method in accordance with the invention for using the thermo roll 10′, 20′, 101′, which thermo roll is intended for the treatment of a fibrous web and the shell of which thermo roll comprises at least two material layers 11′, 13′, 14′, 21′, 23′, 24′, which thermo roll or the shell of which thermo roll is provided with heat transfer means for heating and/or cooling the shell of the thermo roll, advantageously by means of a heat transfer medium, a heat capacity in a range of 100-300 kW/m, preferably in a range of 200-250 kW/m, is transferred to the fibrous web from the thermo roll 10′, 20′, 101′, the shell of which comprises at least two different material layers 11′, 13′, 14′, 21′, 23′, 24′ which are arranged, using a manufacturing technique, radially one within the other, which material layers are manufactured with respect to their manufacturing technique in different stages or by different methods, a system of heat transfer medium flow passages 15′, 25′, 151′, 152′ being placed in at least one of said material layers or confined by at least one of said material layers inside itself or situated in a boundary zone of said material layers, such that the temperature of the heat transfer medium is kept <350° C.

In the second method in accordance with the invention for using the thermo roll 10′, 20′, 101′, which thermo roll is intended for the treatment of a fibrous web and the shell of which thermo roll comprises at least two material layers 11′, 13′, 14′, 21′, 23′, 24′, which thermo roll or the shell of which thermo roll is provided with heat transfer means for heating and/or cooling the shell of the thermo roll, advantageously by means of a heat transfer medium, a heat capacity in a range of 100-300 kW/m, preferably in a range of 200-250 kW/m, is transferred to the fibrous web from the thermo roll 10′, 20′, 101′, the shell of which comprises at least two material layers 11′, 13′, 14′, 21′, 23′, 24′ which are placed radially one within the other and which are different in their thermal conductivities, a system of heat transfer medium flow passages 15′, 25′, 30′, 151′, 152′ being placed in at least one of said material layers or confined by at least one of said material layers inside itself or situated in a boundary zone of said material layers, such that the temperature of the heat transfer medium is kept <350° C.

In one application of the method in accordance with the invention for using the thermo roll 10′, 20′, 101′, during the heating or cooling of the thermo roll, for example, when there is a transition from the running state to the servicing state or vice versa, it is advantageous to use a separate heat transfer passage system 152′ in a material layer 11′, 21′ that conducts less heat to even out the temperature difference inside the thermo roll such that thermal stresses remain in a range that causes no fatigue in the structure.

It is recommended that the thermo roll used in the manufacture and finishing of a fibrous web, in particular a low-gloss matte paper or board, be used in the finishing line of the fibrous web in at least one nip in a device that calenders the fibrous web. Such devices, in particular in the finishing of the fibrous web, include a multinip calender, a soft calender, a machine calender, a belt calender, a metal belt calender and a combination of these. The heatable and coolable thermo roll of the fibrous web machine is intended for the treatment of the fibrous web, for example, for pressing and/or calendering of the fibrous web in contact, i.e. a nip, between the thermo roll and a backing member in contact with the thermo roll.

It is recommended that in said at least one nip, in particular in a nip situated in a finishing line, a thermo roll be used whose heat transfer capacity is high, of the order of 100-400 kW/m.

It is recommended that the flow passages of the thermo roll be placed closer to the outer surface than normal, for example <55 mm to enhance heat transfer.

It is recommended that those parts of the shell of the thermo roll which are significant with respect to heat transfer be manufactured of a material that conducts heat well and whose thermal conductivity λ>70 W/mK.

This material is selected in accordance with one embodiment of the invention from a group that includes copper, ten, aluminum, zinc, chrome, zirconium or an equivalent metal material that conducts heat well or an alloy or a composition metal formed of at least two of these materials. The metal material alloy is CuCrZr in accordance with one embodiment.

It is recommended that the shell of the thermo roll be manufactured at least partly by means of powder metallurgy.

Low-gloss matte paper or board is used as printing, art and photographic paper/board. An essential feature is low gloss, matte quality, of the surface, which nevertheless allows a high-quality and glossy printing result. Thus, the surface of the thermo roll is advantageously manufactured to be porous and coarse in its microstructure such that matte quality is produced in calendering.

To manufacture high-quality matte paper, paper is calendered by means of a porous and small-scale coarse thermo roll provided with a ceramic coating. In accordance with an advantageous embodiment, a coating under the trade name ValMatt is used as the ceramic coating of the thermo roll.

In the method for manufacturing a low-gloss fibrous web, such as matte paper or board, in particular for finishing by calendering, which method uses a thermo roll in accordance with the invention, a fibrous web is calendered by the thermo roll in at least one nip in a multinip calender or a soft calender or a machine calender or a belt calender or a metal belt calender or in a combination of said calenders.

Advantageously, the fibrous web is calendered on the same calender as some other fibrous web grade such that said fibrous web is calendered operating with some of the nips using a smaller number of nips than when calendering other fibrous web grades, in particular glossy grades.

Advantageously, the fibrous web is calendered in a separate nip which is situated in the finishing line and in which there is a thermo roll in accordance with the invention, and which nip can be used or not used when calendering other fibrous web grades, in particular glossy grades.

Advantageously, the calendering of the fibrous web is performed on an uncoated or coated fibrous web. The known methods of coating a fibrous web include, among other things, blade coating, film transfer coating and air brush coating as well as curtain coating and spray coating.

Above, the invention has been described only by way of example by means of some of its advantageous embodiments. This is, of course, not meant to limit the present invention in any way to such single embodiments but, as is clear to a person skilled in the art, various alternative arrangements and modifications as well as applications are feasible within the scope of protection defined by the appended claims.

1-111. (canceled)

112. A thermo roll, in a fibrous web machine for pressing, drying, or cooling a fibrous web, comprising:
a roll shell having an outer web engaging surface, and a thermal conductivity between 300-350 W/mK.

113. The thermo roll of claim 112 wherein the roll shell is a CuCrZr alloy (copper-chrome-zirconium), having a density of 8-10 g/cm³ and an elastic modulus of 100-150 GPa.

114. The thermo roll of claim 112 further comprising a wear resistant coating covering the outer web engaging surface.

115. A thermo roll, in a fibrous web machine for pressing, drying, or cooling a fibrous web, comprising:
a rotating cylindrical shell having an inner surface, and a central axis which defines an axial direction along the axis;
a body formed of at least one part, the body having an outer surface, the body arranged inside the shell;
at least one heat transfer medium flow passage defined by the inner surface of the shell and the outer surface of the body;
a quantity of heat transfer medium within the at least one heat transfer medium flow passage;
a first heat transfer medium conveying means for passing the heat transfer medium into the at least one heat transfer medium flow passage, the first heat transfer medium conveying means having a plurality of inlets into the at least one heat transfer medium flow passage;
a second heat transfer medium conveying means for removing the heat transfer medium from the at least one heat transfer medium flow passage, the second heat transfer medium conveying means having a plurality of outlets from the at least one heat transfer medium flow passage;
a means for controlling flow of the heat transfer medium between the first heat transfer medium conveying means and the second heat transfer medium conveying means;
wherein the inlets into the at least one heat transfer medium flow passage are connected to the first heat transfer medium conveying means, such that the heat transfer medium is supplied into the at least one heat transfer medium flow passage at more than one position along the axis of the cylindrical shell; and
wherein the outlets from the at least one heat transfer medium flow passage are connected to the second heat transfer medium conveying means, such that the heat transfer medium is removed from the at least one heat transfer medium flow passage at more than one position along the axis of the cylindrical shell.

116. A method for manufacturing a thermo roll for the treatment of a fibrous web, the method comprising the steps of:
forming in a first stage a first layer of a shell of the thermo roll, of a first material with a first manufacturing technique;
forming in a second stage a second layer of the shell of the thermo roll of a second material with a second manufacturing technique different from the first manufacturing technique;
arranging the first layer radially inwardly from the second layer of the shell of the thermo roll;
forming heat transfer medium flow passages, each flow passage being confined within the first material layer, the second material layer, or situated in a boundary zone between said first and second material layers; and
heating the fibrous web with the shell of the thermo roll, with a heat transfer medium, and transferring 100-300 kW/m to the fibrous web with a heat transfer medium temperature of less than 350 degrees C.

117. The method of claim 116 wherein the step of transferring 10-300 kW/m to the fibrous web is further limited to transferring 200-250 kW/m to the fibrous web.
